(19) United States
(12) Patent Application Publication
(10) Pub. No.: US 2025/0227808 A1
(43) Pub. Date: Jul. 10, 2025

(54) AUTONOMOUS USER EQUIPMENT DETECTION OF CELL DISCONTINUOUS OPERATION

(71) Applicant: QUALCOMM Incorporated, San Diego, CA (US)

(72) Inventors: Ahmed Attia ABOTABL, San Diego, CA (US); Diana MAAMARI, San Diego, CA (US); Muhammad Sayed Khairy ABDELGHAFFAR, San Jose, CA (US)

(21) Appl. No.: 18/405,856

(22) Filed: Jan. 5, 2024

(51) Int. Cl. H04W 76/28; H04L 5/00; H04W 24/10

(52) U.S. Cl. CPC H04W 76/28; H04L 5/0048; H04L 5/0098; H04W 24/10

(57) ABSTRACT

Methods, systems, and devices for wireless communications are described. A user equipment (UE) may receive one or more control messages that include information associated with whether a cell discontinuous operation is activated or deactivated. The cell discontinuous operation may be associated with a cycle of active periods and non-active periods, and the information may differentiate a first communication within a set of active periods from a second communication outside the set of active periods. The information may include thresholds, signaling configurations, resource allocations, or other information associated with the first communication and the second communication. The UE may indicate a failure to receive an activation message or a deactivation message associated with the cell discontinuous operation based at least in part on whether the cell discontinuous operation is activated or deactivated.

### INTRODUCTION

The following relates to wireless communications, including mechanisms associated with a detection of cell discontinuous operation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications by a user equipment (UE) is described. The method may include receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods and indicating, based on the detection, a failure to receive an activation message or a deactivation message associated with a cell discontinuous operation.

An apparatus for wireless communications at a UE is described. The UE may include one or more memories storing processor executable code and one or more processors coupled with the one or more memories. The one or more processors may be configured to cause the UE to receive one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods and indicate, based on the detection, a failure to receive an activation message or a deactivation message associated with a cell discontinuous operation.

Another apparatus for wireless communications at a UE is described. The apparatus may include means for receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods and means for indicating, based on the detection, a failure to receive an activation message or a deactivation message associated with a cell discontinuous operation.

A non-transitory computer-readable medium storing code for wireless communications is described. The code may include instructions executable by one or more processors to cause a UE to receive one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods and indicate, based on the detection, a failure to receive an activation message or a deactivation message associated with a cell discontinuous operation.

Some examples of the method, apparatus, and non-transitory computer-readable medium described herein may further include operations, features, means, or instructions for receiving, via the information, one or more measurement value thresholds associated with the first communication, the second communication, or both, the indicating the failure based on a comparison of a set of multiple measurements to the one or more measurement value thresholds.

In some examples of the method, apparatus, and non-transitory computer-readable medium described herein, the set of multiple measurements includes one or more first measurements within a first time period and one or more second measurements within a second time period, and the indicating the failure may include operations, features, means, or instructions for indicating a failure to receive the activation message based on the one or more first measurements satisfying a first threshold of the one or more measurement value thresholds and the one or more second measurements failing to satisfy a second threshold of the one or more measurement value thresholds, the first threshold being associated with the set of multiple active periods and the second threshold being associated with the set of multiple non-active periods.

In some examples of the method, apparatus, and non-transitory computer-readable medium described herein, the one or more first measurements may be within at least one of the set of multiple active periods in accordance with the one or more first measurements satisfying the first threshold, and the one or more second measurements being within at least one of the set of multiple non-active periods in accordance with the one or more second measurements failing to satisfy the second threshold.

In some examples of the method, apparatus, and non-transitory computer-readable medium described herein, the set of multiple measurements include one or more first measurements within a first time period and one or more second measurements within a second time period, and the indicating the failure may include operations, features, means, or instructions for indicating a failure to receive the deactivation message based on the one or more first measurements and the one or more second measurements satisfying a threshold of the one or more measurement value thresholds.

Some examples of the method, apparatus, and non-transitory computer-readable medium described herein may further include operations, features, means, or instructions for receiving a reference signal identifier of a reference signal, the set of multiple measurements being associated with the reference signal.

In some examples of the method, apparatus, and non-transitory computer-readable medium described herein, the set of multiple measurements may be associated with one or more reference signal received power measurements, one or more cross link interference measurements, or both.

Some examples of the method, apparatus, and non-transitory computer-readable medium described herein may further include operations, features, means, or instructions for receiving, via the information, a first reference signal sequence associated with the set of multiple active periods and a second reference signal sequence associated with the set of multiple non-active periods and receiving a set of multiple reference signals, the indicating the failure based on whether the set of multiple reference signals may be associated with the first reference signal sequence, or the second reference signal sequence, or both.

Some examples of the method, apparatus, and non-transitory computer-readable medium described herein may further include operations, features, means, or instructions for receiving, within a first time period, one or more first reference signals of the set of multiple reference signals, receiving, within a second time period, one or more second reference signals of the set of multiple reference signals, and indicating a failure to receive the activation message based on the one or more first reference signals being associated with the first reference signal sequence and the one or more second reference signals being associated with the second reference signal sequence.

In some examples of the method, apparatus, and non-transitory computer-readable medium described herein, the indicating the failure may include operations, features, means, or instructions for indicating a failure to receive the deactivation message based on the set of multiple reference signals being associated with the first reference signal sequence.

Some examples of the method, apparatus, and non-transitory computer-readable medium described herein may further include operations, features, means, or instructions for receiving, via the information, a first reference signal sequence associated with the cell discontinuous operation and a second reference signal sequence associated with an absence of the cell discontinuous operation and receiving one or more reference signals, the indicating the failure based on whether the one or more reference signals may be associated with the first reference signal sequence or the second reference signal sequence.

In some examples of the method, apparatus, and non-transitory computer-readable medium described herein, the indicating the failure may include operations, features, means, or instructions for indicating a failure to receive the activation message based on the one or more reference signals being associated with the first reference signal sequence.

In some examples of the method, apparatus, and non-transitory computer-readable medium described herein, the indicating the failure may include operations, features, means, or instructions for indicating a failure to receive the deactivation message based on the one or more reference signals being associated with the second reference signal sequence.

Some examples of the method, apparatus, and non-transitory computer-readable medium described herein may further include operations, features, means, or instructions for receiving, via the information, a first set of resources for communication within the set of multiple active periods and a second set of resources for communication within the set of multiple non-active periods, the indicating the failure based on the first set of resources and the second set of resources.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the first set of resources, and indicating a failure to receive the activation message based on a difference between one or more first failures of the one or more first scheduling requests and one or more second failures of the one or more second scheduling requests satisfying a threshold.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the second set of resources, and indicating a failure to receive the deactivation message based on a difference between one or more first failures of the one or more first scheduling requests and one or more second failures of the one or more second scheduling requests satisfying a threshold.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the second set of resources based on a failure of the one or more first scheduling requests, and indicating a failure to receive the activation message based on a success of the one or more second scheduling requests.

Some examples of the method, apparatus, and non-transitory computer-readable medium described herein may further include operations, features, means, or instructions for transmitting, within a first time period, one or more first scheduling requests in accordance with the second set of resources, transmitting, within a second time period, one or more second scheduling requests in accordance with the first set of resources based on a failure of the one or more first scheduling requests, and indicating a failure to receive the deactivation message based on a success of the one or more second scheduling requests.

Some examples of the method, apparatus, and non-transitory computer-readable medium described herein may further include operations, features, means, or instructions for receiving, via the information, a first set of resources for communication associated with the cell discontinuous operation and a second set of resources for communication associated with an absence of the cell discontinuous operation, the indicating the failure based on the first set of resources and the second set of resources.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the first set of resources, and indicating a failure to receive the activation message based on a difference between one or more first failures of the one or more first scheduling requests and one or more second failures of the one or more second scheduling requests satisfying a threshold.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the second set of resources, and indicating a failure to receive the deactivation message based on a difference between one or more first failures of the one or more first scheduling requests and one or more second failures of the one or more second scheduling requests satisfying a threshold.

Some examples of the method, apparatus, and non-transitory computer-readable medium described herein may further include operations, features, means, or instructions for transmitting, within a first time period, one or more first scheduling requests in accordance with the first set of resources, transmitting, within a second time period, one or more second scheduling requests in accordance with the second set of resources based on a failure of the one or more first scheduling requests, and indicating a failure to receive the activation message based on a success of the one or more second scheduling requests.

Some examples of the method, apparatus, and non-transitory computer-readable medium described herein may further include operations, features, means, or instructions for transmitting, within a first time period, one or more first scheduling requests in accordance with the second set of resources, transmitting, within a second time period, one or more second scheduling requests in accordance with the first set of resources based on a failure of the one or more first scheduling requests, and indicating a failure to receive the deactivation message based on a success of the one or more second scheduling requests.

Some examples of the method, apparatus, and non-transitory computer-readable medium described herein may further include operations, features, means, or instructions for receiving, via the information, a counter value threshold and incrementing a counter based on a satisfaction of one or more criteria included in the information, the indicating the failure to receive the activation message or the deactivation message based on the counter satisfying the counter value threshold.

In some examples of the method, apparatus, and non-transitory computer-readable medium described herein, the indicating the failure may include operations, features, means, or instructions for indicating that an unknown cell discontinuous transmission configuration may have been activated, indicating that a cell discontinuous transmission configuration may have been activated and that the cell discontinuous transmission configuration may be within a set of cell discontinuous transmission configurations, and indicating that a known cell discontinuous transmission configuration may have been activated.

A method for wireless communications by a network entity is described. The method may include outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods, outputting an activation message or a deactivation message associated with a cell discontinuous operation, and communicating with one or more UEs based on outputting the activation message or the deactivation message and the one or more control messages.

An apparatus for wireless communications at a network entity is described. The network entity may include one or more memories and one or more processors coupled with the one or more memories. The one or more processors may be configured to cause the network entity to output one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods, output an activation message or a deactivation message associated with a cell discontinuous operation, and communicate with one or more UEs based on outputting the activation message or the deactivation message and the one or more control messages.

Another apparatus for wireless communications at a network entity is described. The apparatus may include means for outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods, means for outputting an activation message or a deactivation message associated with a cell discontinuous operation, and means for communicating with one or more UEs based on outputting the activation message or the deactivation message and the one or more control messages.

A non-transitory computer-readable medium storing code for wireless communications is described. The code may include instructions executable by one or more processors to cause a network entity to output one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods, output an activation message or a deactivation message associated with a cell discontinuous operation, and communicate with one or more UEs based on outputting the activation message or the deactivation message and the one or more control messages.

Some examples of the method, apparatus, and non-transitory computer-readable medium described herein may further include operations, features, means, or instructions for outputting, via the information, one or more measurement value thresholds associated with the first communication, the second communication, or both, the communicating based on the one or more measurement value thresholds.

Some examples of the method, apparatus, and non-transitory computer-readable medium described herein may further include operations, features, means, or instructions for outputting a reference signal identifier of a reference signal, a set of multiple measurements by the one or more UEs being associated with the reference signal.

In some examples of the method, apparatus, and non-transitory computer-readable medium described herein, the one or more measurement value thresholds may be associated with one or more reference signal received power measurements, one or more cross link interference measurements, or both.

Some examples of the method, apparatus, and non-transitory computer-readable medium described herein may further include operations, features, means, or instructions for outputting, via the information, a first reference signal sequence associated with the set of multiple active periods and a second reference signal sequence associated with the set of multiple non-active periods and outputting a set of multiple reference signals, the communicating based on whether the set of multiple reference signals may be associated with the first reference signal sequence, or the second reference signal sequence, or both.

Some examples of the method, apparatus, and non-transitory computer-readable medium described herein may further include operations, features, means, or instructions for outputting, via the information, a first reference signal sequence associated with the cell discontinuous operation and a second reference signal sequence associated with an absence of the cell discontinuous operation and outputting one or more reference signals, the communicating based on whether the one or more reference signals may be associated with the first reference signal sequence or the second reference signal sequence.

Some examples of the method, apparatus, and non-transitory computer-readable medium described herein may further include operations, features, means, or instructions for outputting, via the information, a first set of resources for communication within the set of multiple active periods and a second set of resources for communication within the set of multiple non-active periods, the communicating based on the first set of resources and the second set of resources.

Some examples of the method, apparatus, and non-transitory computer-readable medium described herein may further include operations, features, means, or instructions for outputting, via the information, a first set of resources for communication associated with the cell discontinuous operation and a second set of resources for communication associated with an absence of the cell discontinuous operation, the communicating based on the first set of resources and the second set of resources.

Some examples of the method, apparatus, and non-transitory computer-readable medium described herein may further include operations, features, means, or instructions for outputting, via the information, a counter value threshold, the communicating based on outputting the counter value threshold.

Some examples of the method, apparatus, and non-transitory computer-readable medium described herein may further include operations, features, means, or instructions for obtaining, from the one or more UEs, an indication of a failure to receive the activation message or the deactivation message associated with the cell discontinuous operation based on outputting the one or more control messages.

Some examples of the method, apparatus, and non-transitory computer-readable medium described herein may further include operations, features, means, or instructions for obtaining an indication that an unknown cell discontinuous transmission configuration may have been activated, obtaining an indication that a cell discontinuous transmission configuration may have been activated and that the cell discontinuous transmission configuration may be within a set of cell discontinuous transmission configurations, and obtaining an indication that a known cell discontinuous transmission configuration may have been activated.

### BRIEF DESCRIPTION OF THE DRAWINGS

FIG. 1 shows an example of a wireless communications system that supports autonomous UE detection of cell discontinuous operation in accordance with one or more aspects of the present disclosure.

FIG. 2 shows an example of a network architecture that supports autonomous UE detection of cell discontinuous operation in accordance with one or more aspects of the present disclosure.

FIG. 3 shows an example of a wireless communications system that supports autonomous UE detection of cell discontinuous operation in accordance with one or more aspects of the present disclosure.

FIGS. 4A and 4B show examples of communication configurations that support autonomous UE detection of cell discontinuous operation in accordance with one or more aspects of the present disclosure.

FIG. 5A shows an example of a communication configuration that supports autonomous UE detection of cell discontinuous operation in accordance with one or more aspects of the present disclosure.

FIG. 5B shows an example of a flowchart that supports autonomous UE detection of cell discontinuous operation in accordance with one or more aspects of the present disclosure.

FIG. 6 shows an example of a communication configuration that supports autonomous UE detection of cell discontinuous operation in accordance with one or more aspects of the present disclosure.

FIG. 7 shows an example of a process flow that supports autonomous UE detection of cell discontinuous operation in accordance with one or more aspects of the present disclosure.

FIGS. 8 and 9 show block diagrams of devices that support autonomous UE detection of cell discontinuous operation in accordance with one or more aspects of the present disclosure.

FIG. 10 shows a block diagram of a communications manager that supports autonomous UE detection of cell discontinuous operation in accordance with one or more aspects of the present disclosure.

FIG. 11 shows a diagram of a system including a device that supports autonomous UE detection of cell discontinuous operation in accordance with one or more aspects of the present disclosure.

FIGS. 12 and 13 show block diagrams of devices that support autonomous UE detection of cell discontinuous operation in accordance with one or more aspects of the present disclosure.

FIG. 14 shows a block diagram of a communications manager that supports autonomous UE detection of cell discontinuous operation in accordance with one or more aspects of the present disclosure.

FIG. 15 shows a diagram of a system including a device that supports autonomous UE detection of cell discontinuous operation in accordance with one or more aspects of the present disclosure.

FIGS. 16 through 21 show flowcharts illustrating methods that support autonomous UE detection of cell discontinuous operation in accordance with one or more aspects of the present disclosure.

### DETAILED DESCRIPTION

Some wireless communications systems may utilize (e.g., employ, use, select, or otherwise leverage) cell discontinuous operation to conserve energy. A cell discontinuous operation may be an operation according to which at least some communications are reduced (e.g., limited or constrained) for some periods. As described herein, “cell discontinuous operation” may be understood as cell DTX or cell DRX or both. Also, “cell DTX/DRX” may be understood as cell DTX alone, cell DRX alone, or both cell DTX and cell DRX. Cell discontinuous operation (e.g., cell DTX/DRX) may be associated with a cycle between active periods and non-active periods. An active period may refer to a period that is intended (e.g., allocated, scheduled) for communications (e.g., transmissions or receptions of communication signals) by a network entity, a UE, or other device. A non-active period may refer to a period in which such communications are reduced relative to an active period (e.g., a network entity and/or UE may reduce transmissions and receptions, devices may enter a low power state in which communications are not performed). For example, in a cell discontinuous transmission (DTX) operation, a network entity (e.g., a via a cell associated with the cell DTX) may reduce (e.g., limit, constrain, or suspend) transmissions by the network entity during non-active periods of the cell DTX operation. In a cell discontinuous reception (DRX) operation, the network entity (e.g., via a cell associated with the cell DRX) may reduce (e.g., limit, constrain, or suspend) receptions by the network entity during non-active periods of the cell DRX operation. Accordingly, the cycle between active and non-active periods may enable devices of a wireless communications system (e.g., the network entity, one or more UEs) to operate with relatively lower energy consumption for at least some periods (e.g., during the non-active periods).

Activation and/or deactivation of cell discontinuous operation may be based on control signaling from a network entity that includes an activation message (e.g., an activation downlink control information (DCI)) or a deactivation message (e.g., a deactivation DCI). As described herein, an “activation message” may refer to a message (e.g., a signal, a communication) that indicates (e.g., to a UE) an activation of a cell discontinuous operation and a “deactivation message” may refer to a message (e.g., a signal, a communication) that indicates deactivation of the cell discontinuous operation. In some cases, however, a UE may fail to receive an activation message or a deactivation message associated with cell discontinuous operation. Accordingly, the UE may incorrectly determine (e.g., select, ascertain, or identify) a mode of operation of the network entity. For example, the network entity may activate cell discontinuous operation (e.g., cell DTX/DRX) and may transmit an activation message to the UE. If the UE fails to detect (e.g., fails to receive and/or fails to successfully decode) the activation message, the UE may incorrectly assume that the network entity is operating in a non-discontinuous operation mode (e.g., a mode other than cell DTX/DRX, a mode that does not include non-active periods). Thus, the UE may attempt to communicate (e.g., transmit, retransmit, monitor, or receive) with the network entity (e.g., an inactive network entity) during a non-active period of the cell discontinuous operation (e.g., while the network entity is operating in accordance with reduced operation). Such a failure to detect an activation message or a deactivation message associated with a cell discontinuous operation may result in relatively inefficient energy (e.g., power) utilization and poor spectral efficiency, among other effects, in a wireless communications system.

In accordance with aspects of the present disclosure, a UE may identify (e.g., ascertain or otherwise determine) a failed detection of an activation message or a deactivation message associated with a cell discontinuous operation (e.g., a cell DTX/DRX operation at a network entity), which may enable the UE to autonomously recover from the failed detection. In some examples, the UE may receive a control message (e.g., a radio resource control (RRC) message, a medium access control (MAC)-control element (MAC-CE), a DCI message, or other control signaling) that includes information (e.g., parameters, configurations, or thresholds) that differentiates (e.g., enables the UE to differentiate) first communications (e.g., reference signals, measurements, or scheduling messages) within active periods (e.g., periods of active communications) from second communications (e.g., reference signals, measurements, or scheduling messages) within non-active periods (e.g., periods of reduced, limited, constrained, or suspended communications) of a cell discontinuous operation (e.g., of a cell DTX/DRX operation, which may be alternatively referred to or understood as a cell DTX/DRX configuration). Additionally, or alternatively, the information may differentiate between a cell discontinuous operation and an absence of the cell discontinuous operation (e.g., a non-cell DTX/DRX operation). In other words, the control message may convey or provide information that a UE may use to determine or identify whether cell DTX/DRX is active or inactive, without a reliance on a detection of an activation or deactivation message.

In some examples, the control message may indicate one or more measurement thresholds associated with the active periods and non-active periods of a cell discontinuous operation. The UE may receive one or more reference signals (e.g., one or more reference signal identifiers, channel state information reference signals (CSI-RSs), demodulation reference signals (DMRSs)) and may perform one or more measurements of the one or more reference signals. In such examples, in the case of a failure to detect an activation/deactivation message, the UE may identify the detection failure based on a comparison of the one or more measurements to the one or more measurement thresholds. In some additional, or alternative, examples, the control message may indicate different reference signal sequences (e.g., based on different sequence roots) or different resources for scheduling request (SR) transmissions that are associated with respective periods of cell discontinuous operations. In such examples, the UE may identify (e.g., determine or ascertain) a failed activation/deactivation message detection based on receiving a reference signal with a given reference signal sequence or based on a failure of one or more SR transmissions. For example, the network entity may apply a particular sequence to a reference signal (e.g., prior to transmission). Accordingly, the network entity may differentiate respective periods, for example, by applying a first sequence to a first reference signal (e.g., a first CSI-RS, a first DMRS) associated with an active period and applying a second sequence to a second reference signal (e.g., a second CSI-RS, a second DMRS) associated with a non-active period. The network entity may indicate such an association to the UE, which the UE may utilize to identify a failed detection of an activation message or a deactivation message.

In some examples, the UE may start (e.g., initiate) and increment a counter to monitor various criteria (e.g., a quantity of measurements that fail to satisfy a threshold, a quantity of reference signals received with a given reference signal sequence, a quantity of failed SR transmissions, or any combination thereof). In some examples, the UE may be configured with (e.g., receive via the information of the control message from the network entity) a counter value threshold. The UE may compare a value of the counter to the counter value threshold, and may identify a failed detection based on the value of the counter satisfying the counter value threshold. In some examples, the UE may indicate (e.g., to higher layers of the UE or to the network entity) the failed activation/deactivation message detection based on identifying the failure.

By applying one or more techniques described herein, a wireless communications system may reduce energy consumption, support higher network energy efficiency, decrease latency, and improve device coordination. For example, a UE may recover from a failure to detect an activation message of a cell DTX/DRX operation, thus enabling the UE to reduce energy (e.g., battery power) consumption for some periods. Further, by enabling a UE to recover from a failure to detect an activation/deactivation message associated with cell DTX/DRX, the UE may selectively perform communications (e.g., transmit and/or retransmit) more in line with network expectations, which may reduce system interference and/or provide additional time-frequency resources for other wireless communication devices or for other communication types, such as sidelink communication between two or more UEs. In accordance with such a reduction in system interference and such a provision of additional time-frequency resources, the described techniques may support more reliable communication, higher data rates, and greater system capacity. Moreover, by improving device coordination such that a UE is able to recover from a failure to detect an activation/deactivation message associated with cell DTX/DRX, the UE may more appropriately request resources for uplink and/or downlink communication based on an understanding (e.g., a determination) of when a serving cell is (or likely will be) active and non-active. Such improved device coordination may result in more appropriately scheduled communication to and/or from the UE, which may in turn support higher data rates, more predictable (or reduced/avoided) latency, and better user experiences related to such higher data rates and more predictable (or reduced/avoided) latency.

Additionally, by enabling or facilitating a detection of a failure to receive an activation/deactivation message based on a comparison of one or more measurements to the one or more measurement thresholds, the described techniques may enable a UE to recover from a detection failure and reduce power consumption without additional signaling overhead at a network entity. Moreover, by enabling or facilitating a detection of a failure to receive an activation/deactivation message based on differently configured reference signal sequences, the described techniques may enable a UE to identify a detection failure at any time, thus reducing latency associated with a recovery from the detection failure. Further, by enabling or facilitating a detection of a failure to receive an activation/deactivation message based on differently configured resources for SR transmissions, the described techniques may enable a UE to recover from a detection failure without a reliance on a reference signal from a network entity thus increasing network power efficiency. Additionally, by using a counter to monitor various criteria (e.g., a quantity of measurements that fail to satisfy a threshold, a quantity of reference signals received with a given reference signal sequence, a quantity of failed SR transmissions, or any combination thereof), the described techniques may improve a capability of a UE to accurately detect a cell discontinuous operation, thus resulting in improved communication reliability.

Aspects of the disclosure are initially described in the context of wireless communications systems. Aspects of the disclosure are further illustrated by and described with reference to communication configurations, a process flow, apparatus diagrams, system diagrams, and flowcharts that relate to autonomous UE detection of cell discontinuous operation.

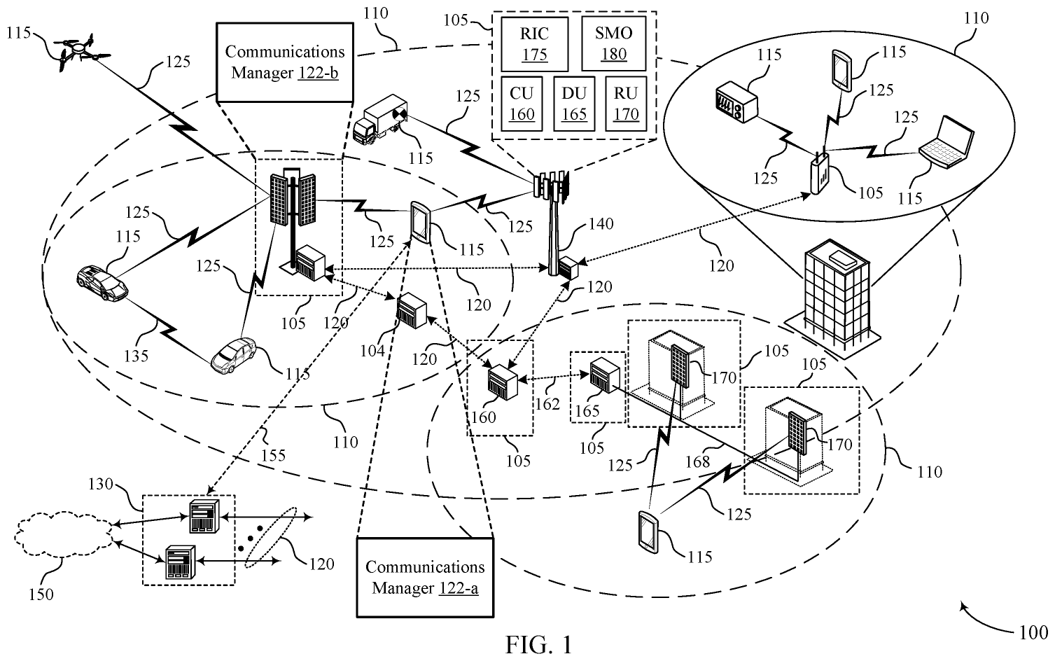

FIG. 1 shows an example of a wireless communications system 100 that supports autonomous UE detection of cell discontinuous operation in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130 (e.g., a next generation core network (NGC)), or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support autonomous UE detection of cell discontinuous operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some wireless communications systems, a network entity 105 (e.g., a cell of a network entity 105) may support a cell DTX operation or a cell DRX operation.

The cell DTX operation or the cell DRX operation may support energy savings at the network entity 105. For example, as part of the cell DTX operation, the network entity 105 may cycle between a DTX active period and a DTX non-active period. During the DTX active period, the network entity 105 may transmit one or more downlink messages. During the DTX non-active period, the network entity 105 (e.g., or a UE 115) may sleep, enter a low power operation, refrain from transmitting the one or more downlink messages, or a combination thereof.

As part of the cell DRX operation, the network entity 105 may cycle between a DRX active period and a DRX non-active period. During the DRX active period, the network entity 105 may monitor one or more uplink channels, receive one or more uplink messages, or a combination thereof. During the DRX non-active period, the network entity 105 (e.g., or a UE 115) may sleep, enter a low power operation, refrain from monitoring the one or more uplink channels or receiving the one or more uplink messages, or a combination thereof. In some examples, the DTX operation or the DRX operation may support various enhancements that may enable the network entity 105 to stay in a low power operation (e.g., sleep operation) for a longer duration, may enable an increased quantity of opportunities for the network entity 105 to enter a low power operation, or a combination thereof, which may support increased energy savings.

In some examples, a UE 115 may be in an RRC connected operation with the network entity 105, and the network entity 105 may align a DRX operation of the UE 115 with a cell DTX/DRX operation of the network entity 105. The network entity 105 may perform inter-node information exchange in accordance with the cell DTX/DRX operation. The network entity 105 may configure enhancements for the cell DTX/DRX operation such that SSB transmission may remain unchanged and such that any impact to idle or inactive UEs 115 may be reduced.

The network entity 105 may activate or deactivate a cell DTX/DRX operation by transmitting an activation or deactivation DCI message. In some examples, the network entity 105 may transmit a group common DCI (e.g., via L1) signaling via a physical downlink control channel (PDCCH)) to multiple UEs 115. In some cases, the group common DCI may not support HARQ feedback (e.g., from a UE 115). The group common DCI message may have a relatively lower reliability than a UE-specific DCI message, which may result in a failure to detect or receive the group common DCI message by one or more of the multiple UEs 115. A format of the group common DCI message may differ from that of a UE-specific DCI message. For example, a group common DCI message may support a defined DCI format (e.g., DCI format 2_6 for power saving information outside DRX active time) or a new DCI format (e.g., DCI format 2_X). The defined DCI format may be associated with monitoring communications within a DRX active time and other field content. The new DCI format may include a field content format. The field content format may include one or more blocks (e.g., block number 1, block number 2, block number N, etc.) for indicating activation or deactivation of a cell DTX/DRX operation, and other field details. In some examples, the blocks may correspond to activation or deactivation of cell DTX/DRX operation at different UEs 115 (e.g., a mapping of a UE 115 and each of the one or more blocks), may differentiate activation or deactivation of a cell DTX operation from activation or deactivation of a cell DRX operation, or a combination thereof. Additionally, or alternatively, a size of the group common DCI may be indicated by higher layers of the network entity 105 and may be associated with an identifier (e.g., a radio network temporary identifier (RNTI)). In some examples, to support a greater reliability of the activation or deactivation message for the cell DTX/DRX operation (e.g., and based on UE capability), the network entity 105 may indicate the activation via a MAC-CE.

During non-active periods of the cell DTX operation, a UE 115 may expect that some signals or channels are not to be received from the network entity 105. A list of signals and/or channels that the network entity 105 refrains from transmitting during the cell DTX operation may be preconfigured (e.g., at the UE 115, at the network entity 105). In some examples, the network entity 105 may not transmit periodic or semi-persistent CSI-RSs that are configured for measurement at the UE 115 via a channel state information (CSI) report configuration message during a DTX non-active period. The CSI-RSs may be configured with a report quantity field that includes a rank indicator. Other examples of signals or channels that may not be transmitted by the network entity 105 during the non-active period of the cell DTX operation may include a PDCCH in a user specific search, a PDCCH in a type-3 common search space, a positioning reference signal, a CSI-RS configured by for radio resource management, a CSI-RS for radio link monitoring and/or beam failure detection, a periodic CSI-RS for tracking (e.g., tracking of a UE 115), a periodic or semi-persistent CSI-RS for beam management, or a combination thereof. A PDCCH in a user specific search or in a type-3 common search space may be associated with a behavior of a UE 115 for retransmission and may include a specific RNTI scrambled PDCCH or may not include the specific RNTI (e.g., may be excluded from a cell DTX operation). A periodic or semi-persistent CSI-RS for beam management may be differentiated from other CSI-RSs used for CSI reports (e.g., for beam management).

During non-active periods of the cell DRX operation, the UE 115 may refrain from transmitting some signals or channels. A list of signals and/or channels that the UE 115 refrains from transmitting during the cell DRX operation may be preconfigured at the UE 115. In some examples, the UE 115 may refrain from transmitting a periodic or semi-persistent CSI report or may refrain from transmitting a periodic or semi-persistent sounding reference signal (SRS) (e.g., for positioning). Additionally, or alternatively, the UE 115 may refrain from transmitting HARQ feedback for a semipersistent physical downlink shared channel (PDSCH). In some cases, a UE 115 may support a same or a different behavior based on whether cell DTX/DRX is activated or deactivated. In some cases, the list of signals or channels that are not to be communicated during non-active periods of cell DTX/DRX may be configured (e.g., by a network entity 105). In some cases, there may be exception cases for a UE 115 receiving or processing the listed signals or channels during the non-active periods of cell DTX/DRX. In some cases, an impact on the wireless communications system 100 may be considered if the list of signals or channels are not communicated during the non-active periods of cell DTX/DRX.

Activation and deactivation of cell discontinuous operations may be based on control signaling (e.g., a group common DCI) from a network entity 105 that includes an activation message or a deactivation message. However, in some cases, a UE 115 may fail to receive the activation message or deactivation message, and may assume an incorrect mode of operation at the network entity 105, which may result in increased energy consumption in the wireless communications system 100. In accordance with techniques herein, a UE 115 may include a communications manager 122-a and a network entity 105 may include a communications manager 122-b, which may enable to the respective devices to perform one or more techniques described herein. In some examples, the UE 115, via or in accordance with the communications manager 122-a, may identify a failed detection (e.g., a missed detection) of a control message associated with a cell discontinuous operation (e.g., a cell DTX/DRX operation at the network entity 105). Accordingly, the UE 115, via or in accordance with the communications manager 122-a, may recover from the failed detection (e.g., and resynchronize with the network entity 105). In some examples, the UE 115, via or in accordance with the communications manager 122-a, may receive a control message that includes information that differentiates between active periods and non-active periods of a cell discontinuous operation or between a cell discontinuous operation (e.g., an active cell DTX/DRX operation) and an absence of the cell discontinuous operation (e.g., an inactive cell DTX/DRX operation).

For example, the UE 115, via or in accordance with the communications manager 122-a, may be configured with one or more measurement thresholds, reference signal sequences, communication resources, or other information associated with respective periods (e.g., active periods vs. non-active periods of a cell DTX/DRX, an active cell DTX/DRX operation vs. an inactive cell DTX/DRX operation) of operations at the network entity 105. Likewise, the network entity 105, via or in accordance with the communications manager 122-b, may configure (e.g., signal, output, provide, transmit) the UE 115 with one or more measurement thresholds, reference signal sequences, communication resources, or other information associated with respective periods (e.g., active periods vs. non-active periods of a cell DTX/DRX, an active cell DTX/DRX operation vs. an inactive cell DTX/DRX operation) of operations at the network entity 105. Additionally, or alternatively, the UE 115, via or in accordance with the communications manager 122-a, may include a counter to monitor various criteria associated with the information. Accordingly, the UE 115, via or in accordance with the communications manager 122-a, may identify cases of failure to receive an activation or deactivation message based on the differentiating information and the counter. In some examples, the UE 115, via or in accordance with the communications manager 122-a, may indicate (e.g., an indication to a higher layer of the UE 115, transmit an indication to the network entity 105) the failure to receive the activation or deactivation message based on identifying whether the cell discontinuous operations is activated or deactivated. Applying one or more techniques described herein may enable the wireless communications system 100 to operate with reduced energy consumption, reduced latency, and increased device coordination.

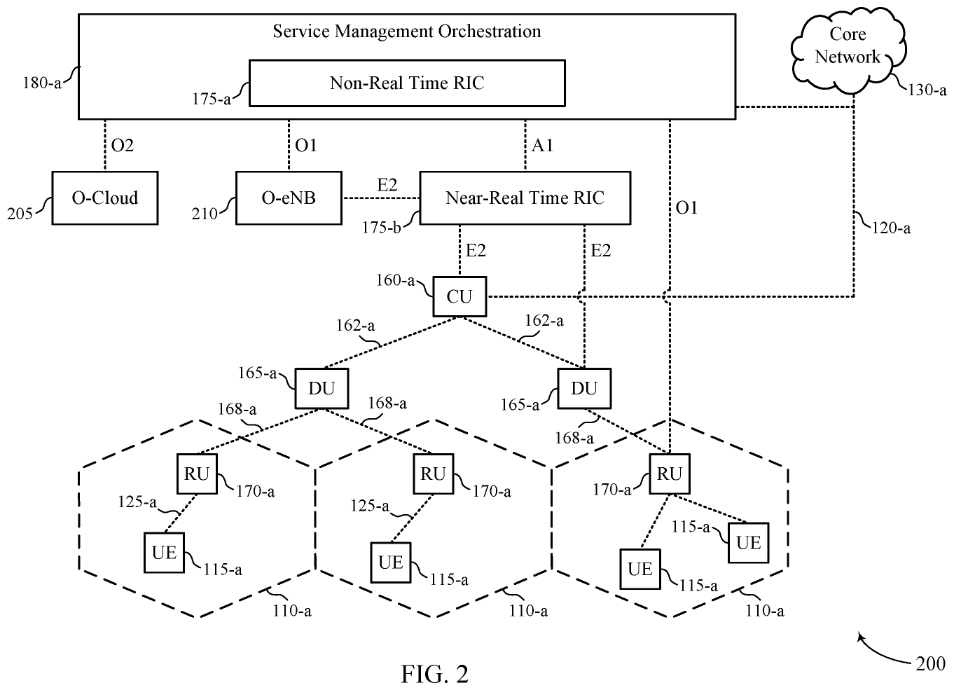

FIG. 2 shows an example of a network architecture 200 (e.g., a disaggregated base station architecture, a disaggregated RAN architecture) that supports autonomous UE detection of cell discontinuous operation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In accordance with techniques described herein, a UE 115-a may identify a failed detection of an activation message or a deactivation message associated with a cell discontinuous operation (e.g., a cell DTX/DRX operation associated with a core network 130-a, a CU 160-a, a DU 165-a, an RU 170-a, or some other device), thus enabling the UE 115-a to autonomously recover from the failed detection. In some examples, the UE 115-a may receive a control message that includes information that differentiates (e.g., or enables the UE 115-a to differentiate) between communications within active periods and non-active periods of a cell discontinuous operation. Additionally, or alternatively, the information may differentiate between a cell discontinuous operation and an absence of the cell discontinuous operation (e.g., a non-DTX/DRX operation). For example, the information may include one or more measurement thresholds, reference signal sequences, resource allocations, or other information associated with respective periods (e.g., active and non-active) of a cell discontinuous operation. Accordingly, in the case of a failure to detect an activation/deactivation message, the UE may identify the failure based on receiving the information. The UE 115-a may indicate (e.g., to a higher layer of the UE 115-a, or to another network device, or both) the failed detection. Application of one or more techniques described herein may enable the network architecture 200 to increase coordination between devices, increase energy savings, and reduce latency.

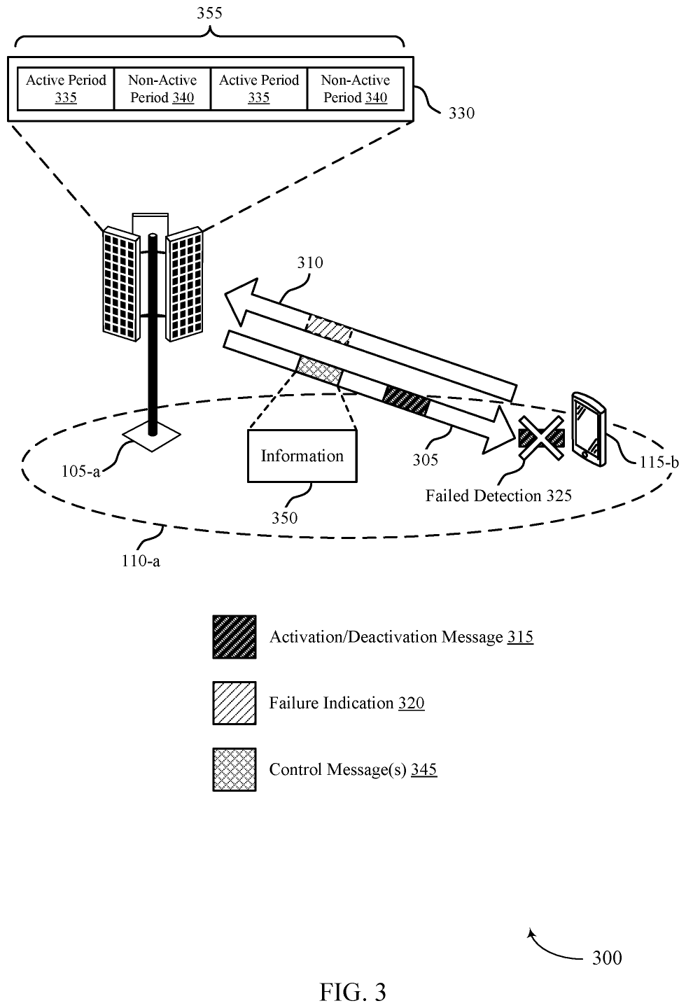

FIG. 3 shows an example of a wireless communications system 300 that supports autonomous UE detection of cell discontinuous operation in accordance with one or more aspects of the present disclosure. The wireless communications system 300 may implement or be implemented by aspects of the wireless communications system 100 or the network architecture 200 as described with reference to FIGS. 1 and 2. For example, the wireless communications system 300 may include a network entity 105-a and a UE 115-b, which may be examples of, or include network entities 105, UEs 115, CUs 160, DUs 165, RUs 170, network nodes, or other devices as described with reference to FIGS. 1 and 2. The network entity 105-a may be associated with a coverage area 110-a (e.g., a cell) that includes one or more UEs 115 including the UE 115-b. The network entity 105-a may communicate with the UE 115-b via a communication link 305 and a communication link 310. The communication link 305 and the communication link 310 may be examples of or include downlink communication interfaces, uplink communication interfaces, or other communication interfaces. For example, the network entity 105-a may communicate downlink signaling (e.g., PDCCH messages, PDSCH messages, activation/deactivation messages 315, control messages 345, or other messages) to the UE 115-b via the communication link 305. The UE 115-b may communicate uplink signaling (e.g., physical uplink control channel (PUCCH) messages, physical uplink shared channel (PUSCH) messages, a failure indication 320). Although a network entity 105-a and a UE 115-b are shown, the techniques herein may be applied by one or more other devices described herein, including with reference to FIGS. 1 and 2. In some examples, the network architecture 200 may support one or more procedures and signaling to identify a failed detection of a message that configures (e.g., activates or deactivates) a cell discontinuous procedure associated with the network entity 105-a.

In some cases, the network entity 105-a may operate in accordance with a cell discontinuous operation 330, where the network entity 105-a (e.g., and one or more UEs 115) may enter a reduced activity state for some periods to support increased energy savings and reduced communication traffic. For example, the cell discontinuous operation 330 may be associated with a cycle 355 of active periods 335 and non-active periods 340. During the non-active periods, the network entity 105-a and the UE 115-b may enter the reduced activity state (e.g., a low power mode) to save power. The cell discontinuous operation 330 may be a cell DTX operation, where the network entity 105-a may reduce (e.g., or pause) transmission activity during non-active periods 340. Additionally, or alternatively, the cell discontinuous operation 330 may be a cell DRX operation, where the network entity 105-a may reduce (e.g., or pause) reception activity during non-active periods 340. In some cases, the network entity 105-a may indicate an activation (e.g., or a deactivation) of a cell discontinuous operation 330 via control signaling to one or more UEs 115 in the coverage area 110-a. For example, the network entity 105-a may transmit one or more activation/deactivation messages 315 (e.g., DCI message, group common DCI signaling, an activation DCI message, a deactivation DCI message) to the UE 115-b that indicate an activation of a cell discontinuous operation 330 or a deactivation of cell discontinuous operation 330.

However, in some cases, the UE 115-b may fail to detect (e.g., fail to receive, missed detection) an activation/deactivation message 315 (e.g., group common DCI signaling for cell DTX/DRX indication may not be reliable), and thus the UE 115-b may not save power during the cell discontinuous operation. Additionally, the network architecture 200 may not support a feedback mechanism (e.g., HARQ feedback) associated with an activation/deactivation message 315 (e.g., for group common signaling). A failed detection 325 of (e.g., a failure to receive) the activation/deactivation message 315 (e.g., a cell discontinuous operation activation or deactivation message, a DTX/DRX group common DCI) may impact operations of the UE 115-b, the network entity 105-a, or both (e.g., with non-negligible side impact). For instance, the UE 115-b may perform operations (e.g., CSI operations, beam management (BM), radio link monitoring (RLM), radio resource management (RRM), loop operations, or other operations) during non-active periods 340 of the cell discontinuous operation 330 (e.g., when downlink signaling is turned off during cell DTX inactive time). That is, the UE 115-b may consume energy (e.g., waste power) to monitor downlink signals (e.g., PDCCH signals) during the non-active periods 340, even though the network entity 105-a (e.g., a gNB) may not transmit downlink signals. Moreover, the network entity 105-a may perform one or more operations (e.g., SRS measurement, physical random access channel (PRACH) monitoring) during a non-active period 340 of a cell discontinuous operation 330 (e.g., cell DRX) based on the failed detection 325.

Thus, the network architecture 200 may experience various adverse effects based on the failed detection 325 for the activation/deactivation message 315. In some cases, a network entity 105-a may transmit multiple repetitions of an activation/deactivation message 315 to increase a likelihood of detection of the activation/deactivation message 315 (e.g., by the UE 115-b). However, repetition of the activation/deactivation message 315 may consume more energy at the network entity 105-a (e.g., based on repeated transmissions) and at the UE 115-b (e.g., based on an increased quantity of blind decoding attempts). Moreover, although the activation/deactivation message 315 may be repeated, the UE 115-b may still fail to detect the activation/deactivation message 315. Thus, mechanisms that enable a UE 115-b to detect whether the network entity 105 activated a cell discontinuous operation 330 (e.g., detection of a missed activation or deactivation message, detection of a failed detection 325) may improve cell discontinuous operations 330 in the network architecture 200. If a UE 115-b detects (e.g., identifies) a failed detection 325 (e.g., a missed activation or deactivation message), the UE 115-b may be enabled to utilize recovery mechanisms to resynchronize with the network entity 105-a (e.g., the UE 115-b may adjust a configuration to communicate with the network entity 105-a accordingly) and decrease potential latency. For instance, if the UE 115-b detects a failed detection 325, the UE 115-b may operate in accordance with the cell discontinuous operation 330 (e.g., may assume cell DTX/DRX activation) without receiving an indication from the network entity 105-a. Additionally, or alternatively, the UE 115-b may support an indication (e.g., a failure indication 320 to report the missed detection of the activation/deactivation message 315) to the network entity 105-a. Accordingly, mechanisms to support detection of a failed detection 325 of an activation/deactivation message 315 may be beneficial for the network architecture 200.

In accordance with techniques described herein, a UE 115-b may identify (e.g., be configured to identify) the failed detection 325 of an activation/deactivation message 315 associated with a cell discontinuous operation 330 (e.g., a cell DTX/DRX operation at the network entity), which may allow the UE 115-b to autonomously recover from the failed detection 325. In some examples, the UE 115-b may receive one or more control messages 345 (e.g., RRC messages, MAC-CE messages, DCI messages, or other control signaling) that include information 350 (e.g., parameters, configurations, thresholds) that differentiates, or that enables the UE 115-b to differentiate, a first communication (e.g., reference signals, measurements, scheduling messages) within one or more active periods 335 from second communications within one non-active period 340 (e.g., or other periods outside of the one or more active periods 335) of the cell discontinuous operation 330 (e.g., of a cell DTX/DRX operation). In some examples, the information 350 may differentiate between a cell discontinuous operation 330 and an absence of the cell discontinuous operation 330 (e.g., a non-DTX/DRX operation).

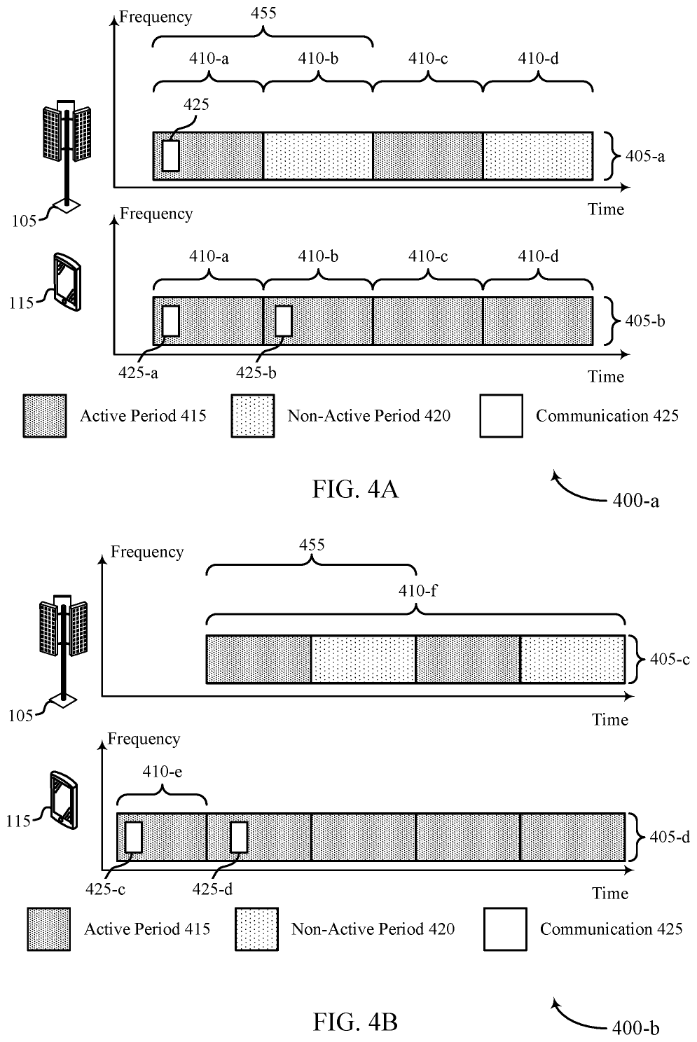

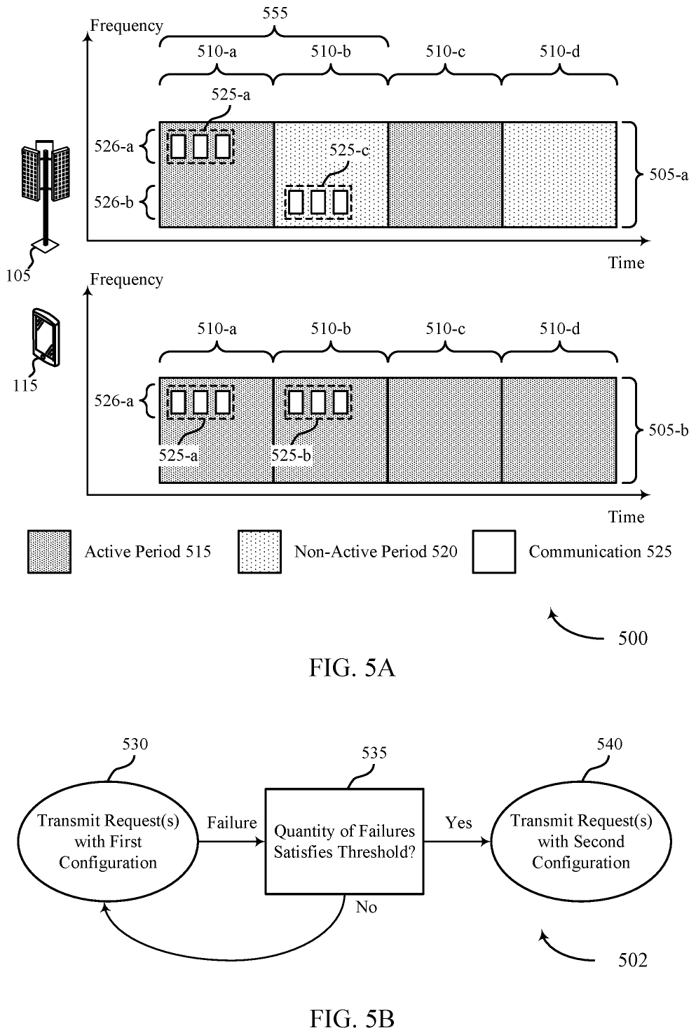

The information 350 of the one or more control messages 345 may include various parameters, thresholds, signaling configurations, resource allocations, or other information associated with respective periods of a cell discontinuous operation 330. In some examples, the information 350 may include one or more measurement thresholds associated with the active periods 335 and non-active periods 340 of the cell discontinuous operation 330. In the case of a failed detection 325, the UE 115-b may identify the failed detection 325 based on a comparison of one or more measurements (e.g., reference signal received power (RSRP) measurements, cross link interference (CLI) measurements) to the one or more measurement thresholds (e.g., as described in greater detail herein including with reference to FIGS. 4 and 5).

Additionally, or alternatively, the information 350 may include multiple reference signal sequences (e.g., based on different sequence roots), or with multiple resources for communications (e.g., SR transmissions), that are associated with respective periods (e.g., active periods 335, non-active periods 340) of the cell discontinuous operation 330 or with other periods outside of the cell discontinuous operation 330. The UE 115-b may identify the failed detection 325 based on receiving a reference signal with a given reference signal sequence or based on a failure of one or more communications (e.g., as described in greater detail herein including with reference to FIGS. 4 and 5). In some examples, the UE 115-b may include a counter to monitor various criteria corresponding to the information 350 and may identify the failed detection 325 based on a value of the counter satisfying a threshold.

In some examples, the UE 115-b may indicate the failed detection 325 to higher layers of the UE 115-b or may transmit a failure indication 320 to the network entity 105-a based on identifying the failed detection 325. Accordingly, the UE 115-b may be enabled to recover (e.g., autonomously) from a failed detection 325. For instance, after a failed detection 325, the UE 115-b may realign its operations to synchronize with the cell discontinuous operation 330 of the network entity 105-a. Additionally, or alternatively, the network entity 105-a may retransmit an activation/deactivation message 315 (e.g., including the activation/deactivation DCI) to resynchronize operations with the UE 115-b. Thus, application of one or more techniques described herein may enable the wireless communications system 300 to increase energy savings, decrease latency, and improve device coordination.

FIGS. 4A and 4B show examples of a communication configuration 400-a and a communication configuration 400-b that support autonomous UE detection of cell discontinuous operation in accordance with one or more aspects of the present disclosure. The communication configuration 400-a and the communication configuration 400-b may include multiple network activity configurations 405 (e.g., a behavior of a network entity 105). In some examples, one or more devices (e.g., a network entity 105, a UE 115, or some other device) of a wireless communications system 100, a network architecture 200, or a wireless communications system 300 (e.g., as described with reference to FIGS. 1 through 3) may operate in accordance with one or more network activity configurations 405.

In the communication configuration 400-a and the communication configuration 400-b, a network activity configuration 405-a and a network activity configuration 405-c may be associated with an activated cell discontinuous operation (e.g., an activated cell DTX/DRX operation). A network activity configuration 405-b and a network activity configuration 405-d may be associated with a deactivated (e.g., non-active) cell discontinuous operation (e.g., a deactivated cell DTX/DRX operation). The network activity configuration 405-a and the network activity configuration 405-c may include a cycle 455 (e.g., a cycle 355) between an active period 415 (e.g., Tx active times) and a non-active period 420 (e.g., Tx inactive times), while the network activity configuration 405-b and the network activity configuration 405-d may not include non-active periods 420. The network activity configurations 405 may include respective communications 425 (e.g., reference signals, measurement of reference signals) during various periods 410.

In some cases, a network entity 105 may activate a cell DTX operation and may transmit an activation message (e.g., an activation DCI) to a UE 115 to indicate that the cell DTX is activated. A UE 115 may monitor for the activation message within a monitoring window to identify whether the cell DTX operation is activated or not activated. However, a UE 115 may fail to receive (e.g., miss) the activation message, and the UE 115 may incorrectly determine that the cell DTX operation is deactivated. For example, the network entity 105 may operate in accordance with a first network activity configuration (e.g., a network activity configuration 405-a, network activity configuration 405-c, an actual network activity), but the UE 115 may assume that the network entity 105 operates in accordance with a second network activity configuration (e.g., a network activity configuration 405-b, network activity configuration 405-d, an assumed network activity). Thus, the UE 115 and the network entity 105 may be operate in accordance with different configurations.

In some examples, a UE 115 may identify a beginning (e.g., a potential DTX activation start time) of activation of a cell DTX (e.g., within a monitoring window for an activation DCI of a cell DTX operation), the UE 115 may be configured to detect a cell DTX operation activation (e.g., in case of missing the activation DCI). For example, the UE 115 may be configured (e.g., by a network entity 105, via the information 350 of one or more control messages 345) with one or more thresholds (e.g., Th_active and Th_inactive, measurement thresholds) to differentiate between the active periods 415 and the non-active periods 420. The UE 115 may also be configured (e.g., via the information 350) with a counter (e.g., a DTX_detection_failure_counter, a counter initiated with 1) and a counter value threshold (e.g., DTX_detection_failure_counter_max). The UE 115 may also be configured with reference signal identifier (e.g., associated with one more reference signals to be measured by the UE 115).

In the communication configuration 400-a, a network entity 105 may operate in accordance with the network activity configuration 405-a (e.g., an activated cell discontinuous operation) and a UE 115 may have failed to detect an activation message (e.g., a deactivation DCI). In accordance with failing to detect the activation message, the UE 115 may (incorrectly) assume a network activity configuration 405-b. Accordingly, the network entity 105 may transmit a communication 425 (e.g., a reference signal, a reference signal corresponding to the reference signal identifier) in a first period 410-a (e.g., an active period 415), which may correspond to a first communication 425-a received at the UE 115. The network entity 105 may not transmit a communication 425 (e.g., when the cell DTX operation is activated) in a second period 410-b (e.g., a non-active period 420). The UE 115 may perform a first measurement for the first communication 425-a (e.g., may measure an RSRP of the reference signal) within the first period 410-a and may perform a second measurement for a second communication 425-b (e.g., for a reference signal that the UE expects to receive but that is not transmitted by the network entity 105) within the second period 410-b. The UE 115 may compare the first measurement (e.g., first RSRP) of the first communication 425-a and the second measurement (e.g., second RSRP) of the second communication 425-b. If the UE 115 detects that the first measurement satisfies a first threshold (e.g., Th_active) and the second measurement fails to satisfy a second threshold (e.g., Th_inactive, when the first RSRP is greater than Th_active and the second RSRP is less than Th_active), the UE may increment a counter (e.g., DTX_detection_failure_counter). In some examples, if the counter satisfies the counter value threshold (e.g., DTX_detection_failure_counter_max), the UE may declare (e.g., indicate) a cell DTX activation detection failure. For example, the UE 115 may determine that a first measurement within a first period 410-a satisfies a threshold, a second measurement within a second period 410-b fails to satisfy the threshold (e.g., because a reference signal was not transmitted within the second period 410-b), a third measurement within a third period 410-c satisfies the threshold, and a fourth measurement within a fourth period 410-d fails to satisfy the threshold.

In some examples, if a network entity 105 configures a UE 115 with multiple configurations (e.g., a first configuration for to active periods 415 and a second configuration for non-active periods 420), a mismatch in configurations may be used to implicitly detect a cell DTX activation. For example, some reference signals (e.g., CSI-RSs, DMRSs) may be transmitted by the network entity 105 during non-active periods 420. The UE 115 may be configured with a first reference signal sequence (e.g., based on a sequence root) for a first reference signal (e.g., first CSI-RS, a first DMRS) transmitted in the active periods 415 and a second reference signal sequence (e.g., based on a different sequency root) for a second reference signal (e.g., a second CSI-RS, a second DMRS) transmitted during the non-active periods 420. During an assumed non-active period 420 (e.g., assumed inactive duration), the UE 115 may make multiple hypothesis for the reference signal sequences (e.g., CSI-RS sequences, DMRS sequences). If a reference signal sequence associated with a non-active period 420 is detected (e.g., via a correlation operation), the UE 115 may declare (e.g., indicate) detection of cell DTX activation.

In the communication configuration 400-b, the network may have multiple configurations associated with a cell DTX operation (e.g., a network activity configuration 405-c) versus a non-cell DTX operation (e.g., a network activity configuration 405-d), and the UE 115 may be configured to differentiate between the cell DTX operation activity and non-cell DTX operation activity. For instance, the network entity 105 may operate in accordance with the network activity configuration 405-c and the UE 115 may have failed to detect an activation message (e.g., a deactivation DCI). In accordance with failing to detect the activation message, the UE 115 may (incorrectly) assume a network activity configuration 405-d. The UE 115 may use a hypothesis of a cell DTX configuration to detect a cell DTX configuration. For instance, the UE 115 may be configured with a first reference signal sequence associated with a non-cell DTX operation (e.g., for a first reference signal transmitted with a first period 410-e) and a second reference signal sequence associated with a cell-DTX operation (e.g., for a second reference signal transmitted with a second period 410-f).

The UE 115 may indicate a detection of a cell DTX activation based on determining that a reference signal is received in accordance with the second reference signal sequence. For example, the network entity 105 may initially operate in a non-cell DTX operation during a first period 410-e and may transmit a first communication 425-c in accordance with the first reference signal sequence associated with a non-cell DTX operation. The network entity 105 may activate a cell DTX operation for a second period 410-f, and may transmit a second communication 425-d associated with a cell-DTX operation. The UE may receive the second communication and may expect (e.g., hypothesize) the second communication 425-d to be associated with the first reference signal sequence. However, the UE 115 may determine that the second communication 425-d is associated with the second reference signal sequence and may indicate a detection of the cell DTX operation. In such examples, the different reference signal sequences for different periods 410 may enable the UE 115 to detect a cell DTX activation during active periods 415.

Additionally, or alternatively, a network entity 105 may deactivate a cell discontinuous operation (e.g., may operate in accordance with a network activity configuration 405-b or a network activity configuration 405-d) and a UE 115 may have failed to detect a deactivation message (e.g., a deactivation DCI). In accordance with failing to detect the deactivation message, the UE 115 may (incorrectly) assume a network activity configuration 405-a or a network activity configuration 405-c. In such examples, the UE 115 may detect a deactivation of cell DTX operation by determining that a measurement (e.g., a measured RSRP) is within a same range within active periods 415 and non-active periods 420 (e.g., within active and inactive time). In other words, a measurement value may be greater than a threshold value (e.g., Th_active) at all times, and the UE 115 may accordingly detect a deactivation of cell DTX. For example, a UE 115 may operate in accordance with the network activity configuration 405-a and a network entity 105 may operate in accordance with the network activity configuration 405-b. Accordingly, the UE 115 may expect to receive a communication 425 (e.g., a reference signal) within a first period 410-a and may not expect to receive a communication 425 within a second period 410-b. However, the UE 115 may detect that a cell discontinuous operation was deactivated based on a first measurement (e.g., of an RSRP of the communication 425) within the first period 410-a satisfying a threshold value and a second measurement (e.g., of an RSRP of the communication 425) within the second period 410-b satisfying the threshold value. In some additional, or alternative, examples, the UE 115 may detect a deactivation of cell DTX operation based on a mismatch between multiple reference signal configurations associated with respective periods 410 (e.g., following similar techniques as in the case of detection of activated cell DTX).

FIG. 5A shows an example of a communication configuration 500 that supports autonomous UE detection of cell discontinuous operation in accordance with one or more aspects of the present disclosure. FIG. 5B shows an example of a flowchart 502 that supports autonomous UE detection of cell discontinuous operation in accordance with one or more aspects of the present disclosure. The communication configuration 500 may include multiple network activity configurations 505 (e.g., a behavior of a network entity 105). In some examples, one or more devices (e.g., a network entity 105, a UE 115, or some other device) of a wireless communications system 100, a network architecture 200, or a wireless communications system 300 (e.g., as described with reference to FIGS. 1 through 3) may operate in accordance with one or more network activity configurations 505. In some examples, the flowchart 502 may be associated with the communication configuration 500. For example, a UE 115 may transmit respective communication 525 in accordance with the flowchart 502.

In the communication configuration 500, a network activity configuration 505-a may be associated with an active cell discontinuous operation (e.g., an activated cell DTX/DRX operation). and a network activity configuration 505-b may be associated with a non-active cell discontinuous operation (e.g., a deactivated cell DTX/DRX operation). The network activity configuration 505-a may include a cycle 555 (e.g., a cycle 355) between an active period 515 (e.g., Rx active times) and a non-active period 520 (e.g., Rx inactive times), while the network activity configuration 505-b may not include non-active periods 520. The network activity configurations 505 may include respective communication 525 (e.g., SRs, reference signals, measurement of reference signals) during various periods 510.

In some cases, a network entity 105 may activate a cell DRX operation and may transmit an activation message (e.g., an activation DCI) to a UE 115 to indicate that the cell DRX is activated. A UE 115 may monitor for the activation message within a monitoring window to identify whether the cell DRX operation is activated or not activated. However, a UE 115 may fail to receive (e.g., miss) the activation message, and the UE 115 may incorrectly determine that the cell DRX operation is deactivated. For example, the network entity 105 may operate in accordance with a first network activity configuration 505-a (e.g., actual network activity), and the UE 115 may assume that the network entity 105 operates in accordance with a second network activity configuration 505-b (e.g., assumed network activity).

In some examples, a UE 115 may be configured to identify a beginning of an activation of a cell DRX (e.g., within a monitoring window for the activation DCI of cell DRX), and the UE may miss an activation message. To detect the missed activation message, a network entity 105 may configure multiple SR configurations (e.g., for communication 525) for active periods 515 and non-active periods 520 (e.g., a first configuration for SRs transmitted in active periods 515 and a second configuration for SRs transmitted in non-active periods 520). For instance, SR attempts may be transmitted in some occasions and a UE 115 may wait (e.g., according to a timer) for a response before it repeats the SR attempts.

In some examples (e.g., when there is a potential miss-detection of cell DRX activation), the UE 115 may detect a failure to receive a cell DRX activation message via one or more SR failures. For example, the UE 115 may count a first quantity of failures of one or more SRs during non-active periods 520 (e.g., potential inactive times) and may compare it with a second quantity of failures of one or more SR during active periods 515 (e.g., active times). If a difference between the first quantity of failures and the second quantity of failures is larger than a configured threshold, the UE may assume (e.g., and indicate) a detection of cell DRX activation. Additionally, or alternatively, when a UE 115 detects a failure of one or more SRs during a non-active period 520, the UE 115 may switch to a configuration for SR occasions associated with a cell DRX duration. If the SR is successful after switching the configurations, the UE 115 may assume (e.g., and indicate) a detection of cell DRX activation.

The flowchart 502 may show an example process (e.g., at a UE 115). At 530, the UE 115 (e.g., operating in accordance with a network activity configuration 505-b) may transmit one or more first SRs 525-a within a first period 510-a in accordance with a first configuration (e.g., associated with active periods 515 of a cell, a first set of resources 526-a). The network entity 105 may successfully receive the one or more first SRs 525-a, and accordingly the UE 115 may not identify a failure associated with the one or more first SRs 525-a. The UE 115 may transmit one or more second SRs 525-b within a second period 510-b in accordance with the first configuration. However, the network entity 105 may expect to receive one or more third SRs 525-c in accordance with a second configuration (e.g., associated with non-active periods 520 of a cell, a set of resources 526-b), and may fail to receive the one or more second SRs 525-b from the UE 115. Accordingly, the UE 115 may identify (e.g., may receive an indication from the network entity 105, may fail to receive a response to the one or more second SRs 525-b) one or more failures associated with the one or more second SRs 525-b. At 535, the UE 115 may determine whether a quantity of failures of the SRs satisfies (e.g., is greater than) a threshold. If the quantity of failures fails to satisfy the threshold, the process may return to 530 and the UE 115 may continue to transmit SRs in accordance with the first configuration. If the quantity of failures satisfies the threshold, the process may proceed to 540 and the UE 115 may transmit one or more third SRs 525-c in accordance with the second configuration (e.g., associated with a non-active period 520 of the cell DRX operation).

Additionally, or alternatively, the UE 115 may utilize one or more CLI measurements to identify an activated cell DRX operation. For instance, one or more SRSs may be transmitted by a network entity 105 during assumed network activity. For instance, the UE 115 may receive information that includes one or more measurement thresholds associated with the one or more CLI measurements. A first threshold may be associated with active periods 515 and a second threshold may be associated with non-active periods 520. For example, a first CLI measurement within a period 510-c may satisfy a threshold and a second CLI measurement within a second period 510-d may fail to satisfy the threshold. The UE 115 may identify (e.g., realize) the pattern (e.g., a high-low interference pattern) and determine that an activation message (e.g., or a deactivation message) was missed.

In some examples, the UE may also be configured (e.g., via the information 350) with a counter (e.g., a DRX_detection_failure_counter to be initiated with 1) and a counter value threshold (e.g., a DRX_detection_failure_counter_max). The UE 115 may increment the counter based on determining that a CLI measurement fails to satisfy a threshold. When the counter satisfies (e.g., reaches) the counter value threshold (e.g., value of DRX_detection_failure_counter_max) the UE 115 may declare a DRX activation detection failure.

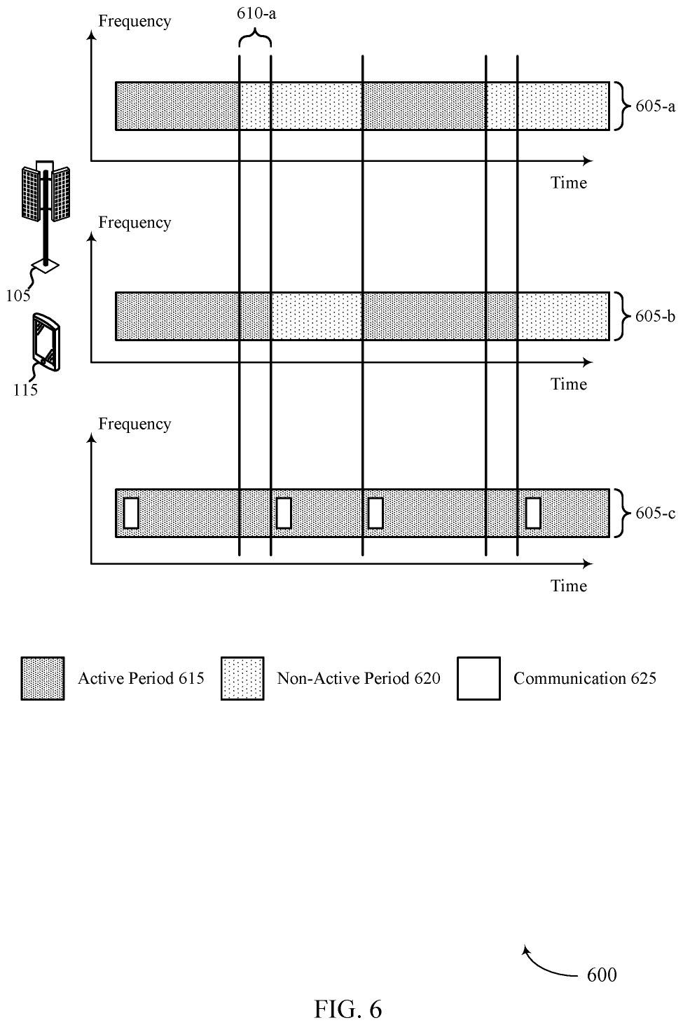

FIG. 6 shows an example of a communication configuration 600 that supports autonomous UE detection of cell discontinuous operation in accordance with one or more aspects of the present disclosure. The communication configuration 600 may include multiple network activity configurations 605 (e.g., a behavior of a network entity 105). In some examples, one or more devices (e.g., a network entity 105, a UE 115, or some other device) of a wireless communications system 100, a network architecture 200, or a wireless communications system 300 (e.g., as described with reference to FIGS. 1 through 3) may operate in accordance with one or more network activity configurations 605.

In the communication configuration 600, a network activity configuration 605-a and a network activity configuration 605-b may be associated with an active cell discontinuous operation (e.g., an activated cell DTX/DRX operation). A network activity configuration 605-c may be associated with a non-active cell discontinuous operation (e.g., a deactivated cell DTX/DRX operation). The network activity configuration 605-a may include active periods 615 (e.g., Tx/Rx active times) and non-active periods 620 (e.g., Rx inactive times). The network activity configurations 605 may include respective communications 625 (e.g., SRs, reference signals, measurement of reference signals) during various periods 610. In some cases, a network entity 105 may activate a cell DTX/DRX operation and may transmit an activation message (e.g., an activation DCI) to a UE 115 to indicate that the cell DRX is activated. However, a UE 115 may fail to receive (e.g., miss) the activation message.

In some examples, the UE 115 may be configured with multiple Cell discontinuous operation configurations (e.g., multiple cell DTX configurations). Each configuration may be associated with a respective periodicity and duty cycle between the active periods 615 and non-active periods 620 (e.g., and may not align in time, may be associated with a different cycle 355). For instance, the network activity configuration 605-a and the network activity configuration 605-b may both be associated with a cell discontinuous operation, but may have different periodicities and duty cycles. During a period 610-a, the network activity configuration 605-a may be in a non-active period 620 but the network activity configuration 605-b may be in an active period 615.

In such examples, the UE 115 may be able to detect activation detection failure associated with multiple cell discontinuous operation configurations. For instance, a UE 115 may detect that a cell DTX/DRX operation is activated and may not determine a specific configuration associated with the cell DTX/DRX operation (e.g., may indicate that an unknown cell discontinuous operation has been activated). In some examples, a UE 115 may detect that a cell DTX/DRX operation is activated and may determine that the cell DTX/DRX operation is associated with a given set of cell DTX/DRX operation configurations (e.g., may indicate a set of cell discontinuous operations). In some examples, a UE 115 may detect that a cell DTX/DRX operation is activated and may determine a specific configuration for the cell DTX/DRX operation (e.g., may indicate a known cell discontinuous operation has been activated).

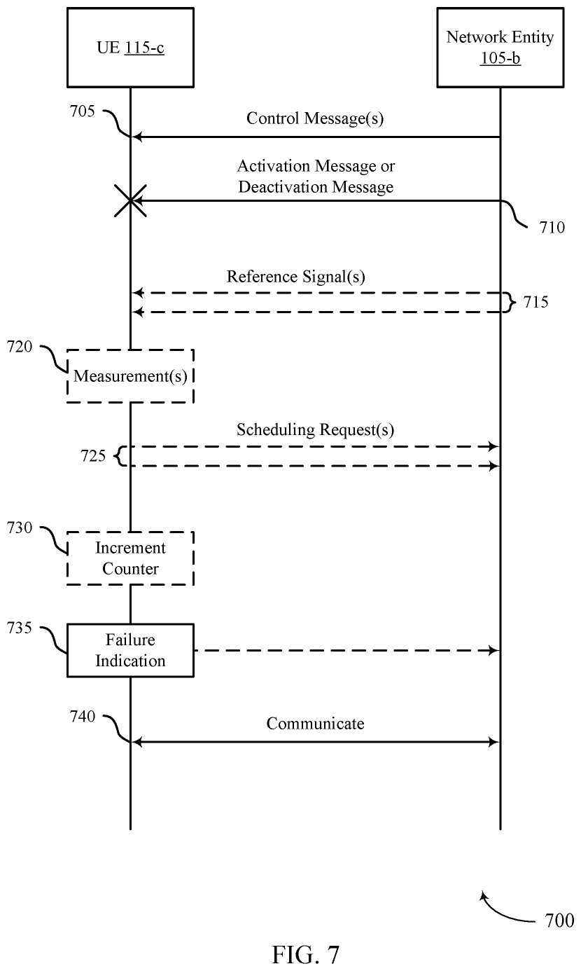

FIG. 7 shows an example of a process flow 700 that supports autonomous UE detection of cell discontinuous operation in accordance with one or more aspects of the present disclosure. In some examples, process flow 700 may implement aspects of the wireless communications system 100, the network architecture 200, the wireless communications system 300, among other aspects as described with reference to FIGS. 1 through 6. For example, the process flow 700 may support signaling between a UE 115-c and a network entity 105-b to enable autonomous detection of cell discontinuous operations. The UE 115-c and the network entity 105-b of the process flow 700 may be examples of corresponding devices herein, including with reference to FIGS. 1 through 6.

In the following description of process flow 700, the operations between the UE 115-c and the network entity 105-b may be performed in a different order than the order shown, or other operations may be added or removed from the process flow 700. For example, some operations may also be left out of process flow 700, or may be performed in different orders or at different times. Further, although some operations or signaling may be shown to occur at different times for discussion purposes, these operations may actually occur at the same time. Although the UE 115-c and the network entity 105-b are shown performing the operations of process flow 700, some aspects of some operations may also be performed by one or more other wireless or network devices.

At 705, the UE 115-c may receive one or more control messages that include information associated with a detection of an activated cell discontinuous operation or a deactivated cell discontinuous operation. The activated cell discontinuous operation may be associated with a cycle that includes a set of multiple of active periods and a set of multiple of non-active periods. The information may differentiate a first communication (e.g., reference signals, SRs, reference signal measurements) during the set of multiple of active periods from a second communication outside of the set of multiple of active periods (e.g., within non-active periods). In some examples, the information may include one or more measurement value thresholds associated with the first communication, the second communication, or both. In some examples, the information may include a first reference signal sequence associated with the set of multiple of active periods and a second reference signal sequence associated with the set of multiple of non-active periods. In some examples, the information may include a first reference signal sequence associated with the cell discontinuous operation and a second reference signal sequence associated with an absence of the cell discontinuous operation. In some examples, the information may include a first set of resources for communication within the set of multiple of active periods and a second set of resources for communication within the set of multiple of non-active periods. In some examples, the information may include a first set of resources for communication associated with the cell discontinuous operation and a second set of resources for communication associated with an absence of the cell discontinuous operation. In some examples, the information may include a counter value threshold. In some examples, the UE 115-c may receive a reference signal identifier of a reference signal, and a set of multiple of measurements may be associated with a reference signal corresponding to the reference signal identifier.

At 710, the network entity 105-b may output an activation message or a deactivation message associated with a cell discontinuous operation. The activation message or the deactivation message may be a control message (e.g., a DCI message, a group common DCI message). In some examples, the UE 115-c may fail to detect the activation message or the deactivation message.

At 715, the UE 115-c may receive one or more reference signals (e.g., in accordance with the information). For example, the UE 115-c may receive, within a first time period (e.g., within an active period), one or more first reference signals and may receive, within a second time period (e.g., within a non-active period), one or more second reference signals of the set of multiple of reference signals.

At 720, the UE 115-c may perform one or more measurements (e.g., associated with the one or more reference signals). In some examples, the one or more measurements may include one or more first measurements within a first time period (e.g., an active period) and one or more second measurements within a second time period (e.g., a non-active period). In some examples, the UE 115-c may determine that the one or more first measurements are within at least one of the set of multiple of active periods in accordance with the one or more first measurements satisfying a first threshold (e.g., Th_active) and determine that the one or more second measurements are within at least one of the set of multiple of non-active periods in accordance with the one or more second measurements failing to satisfy a second threshold (e.g., Th_inactive). In some examples, the one or more measurements may be associated with one or more RSRP measurements, one or more CLI measurements, other measurements, or any combination thereof.

At 725, the UE 115-c may transmit one or more SRs (e.g., in accordance with the received information). For example, the UE 115-c may transmit, within a first time period (e.g., a network active period), one or more first SRs in accordance with a first set of resources for communication (e.g., associated with active periods). The UE 115-c may transmit, within a second time period (e.g., a network non-active period), one or more second SRs in accordance with the first set of resources. Alternatively, the UE 115-c may transmit the one or more first SRs in accordance with the first set of resources and transmit the one or more second SRs in accordance with a second set of resources for communication. (e.g., associated with non-active periods).

In some examples, the UE 115-c may transmit, within a first time period, one or more first SRs in accordance with the first set of resources and may transmit, within a second time period, one or more second SRs in accordance with the second set of resources based on a failure of the one or more first SRs. Alternatively, the UE 115-c may transmit the one or more first SRs in accordance with the second set of resources and may transmit the one or more second SRs in accordance with the first set of resources based on a failure of the one or more first SRs.

At 730, the UE 115-c may increment a counter based on a satisfaction of one or more criteria included in the information. For example, the UE 115-c may increment the counter based on a measurement satisfying (e.g., or failing to satisfy) a threshold, based on receiving a reference signal with a reference signal sequence, based on a failure of one or more SRs, or other criteria associated with the received control messages.

At 735, the UE 115-c may indicate, based on the detection, a failure to receive an activation message or a deactivation message associated with the cell discontinuous operation. In some examples, the UE 115-c may indicate the failure to a higher layer of the UE 115-c. Additionally, or alternatively, the network entity 105-b may obtain, from the UE 115-c, the indication of the failure to receive the activation message or the deactivation message associated with the cell discontinuous operation based on outputting the one or more control messages.

In some examples, the UE 115-c may indicate a failure to detect an activation message or a deactivation message based on a comparison of one or more measurements to the one or more measurement value thresholds included in the information. For example, the UE 115-c may indicate a failure to receive the activation message based on one or more first measurements satisfying a first threshold of one or more measurement value thresholds and one or more second measurements failing to satisfy a second threshold of the one or more measurement value thresholds. The first threshold may be associated with a set of multiple of active periods and the second threshold may be associated with a set of multiple of non-active periods. Additionally, or alternatively, the UE 115-c may indicate a failure to receive a deactivation message based on the one or more first measurements and the one or more second measurements satisfying a threshold (e.g., a same threshold) of the one or more measurement value thresholds.

In some examples, the UE 115-c may indicate the failure based on whether the one or more reference signals are associated with the first reference signal sequence, or the second reference signal sequence, or both. For example, the UE 115-c may indicate a failure to receive the activation message based on the one or more first reference signals being associated with the first reference signal sequence and the one or more second reference signals being associated with the second reference signal sequence. Additionally, or alternatively, the UE 115-c may indicate a failure to receive an activation message or a deactivation message based on the one or more reference signals being associated with a same reference signal sequence.

In some examples, the UE 115-c may indicate the failure based on the first set of resources and the second set of resources included in the information. For example, the UE 115-c may indicate a failure to receive an activation message or a deactivation message based on a difference between one or more first failures of the one or more first SRs and one or more second failures of the one or more second SRs satisfying a threshold. In some examples, the UE 115-c may indicate a failure to receive an activation message or a deactivation message based on a success of the one or more second SRs (e.g., SRs transmitted after switching to a second communication configuration).

In some examples, the UE 115-c may indicate the failure to receive the activation message or the deactivation message may be based on incrementing the counter. For example, the UE 115-c may indicate the failure based on the counter satisfying a counter value threshold. In some examples, the UE 115-c may indicate that an unknown cell DTX/DRX configuration has been activated, or that a cell DTX/DRX configuration has been activated and that the cell DTX/DRX configuration is within a set of cell DTX/DRX configurations, or that a known cell DTX/DRX configuration has been activated, or any combination thereof.

At 740, the UE 115-c and the network entity 105-b may communicate (e.g., the network entity 105-b may communicate with one or more UEs 115 including the UE 115-c) based on outputting the activation message or the deactivation message and the one or more control messages. For instance, the UE 115-c may be enabled to recover from a failed detection of an activation or a deactivation message based on receiving the one or more control messages. Thus, the UE 115-c and the network entity 105-b may synchronously communicate in accordance with a cell discontinuous operation or a non-cell discontinuous operation.

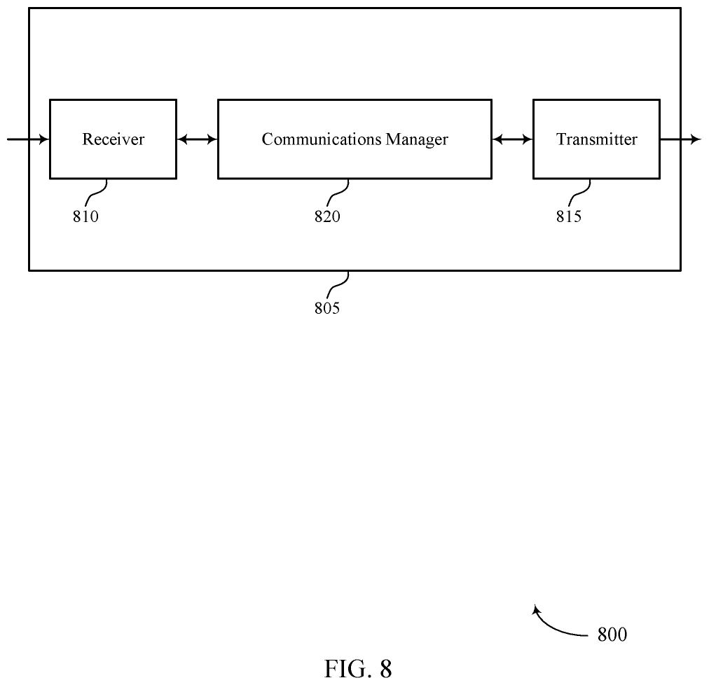

FIG. 8 shows a block diagram 800 of a device 805 that supports autonomous UE detection of cell discontinuous operation in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to autonomous UE detection of cell discontinuous operation).

Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to autonomous UE detection of cell discontinuous operation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of autonomous UE detection of cell discontinuous operation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, determining, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The communications manager 820 is capable of, configured to, or operable to support a means for indicating, based on the detection, a failure to receive an activation message or a deactivation message associated with a cell discontinuous operation.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

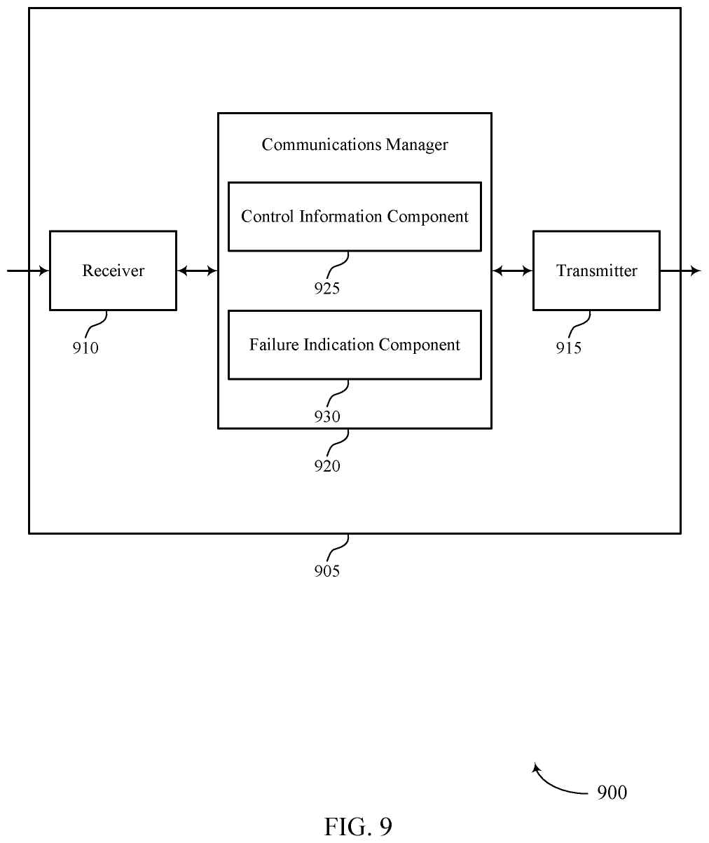

FIG. 9 shows a block diagram 900 of a device 905 that supports autonomous UE detection of cell discontinuous operation in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to autonomous UE detection of cell discontinuous operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to autonomous UE detection of cell discontinuous operation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of autonomous UE detection of cell discontinuous operation as described herein. For example, the communications manager 920 may include a control information component 925 a failure indication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, determining, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The control information component 925 is capable of, configured to, or operable to support a means for receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The failure indication component 930 is capable of, configured to, or operable to support a means for indicating, based on the detection, a failure to receive an activation message or a deactivation message associated with a cell discontinuous operation.

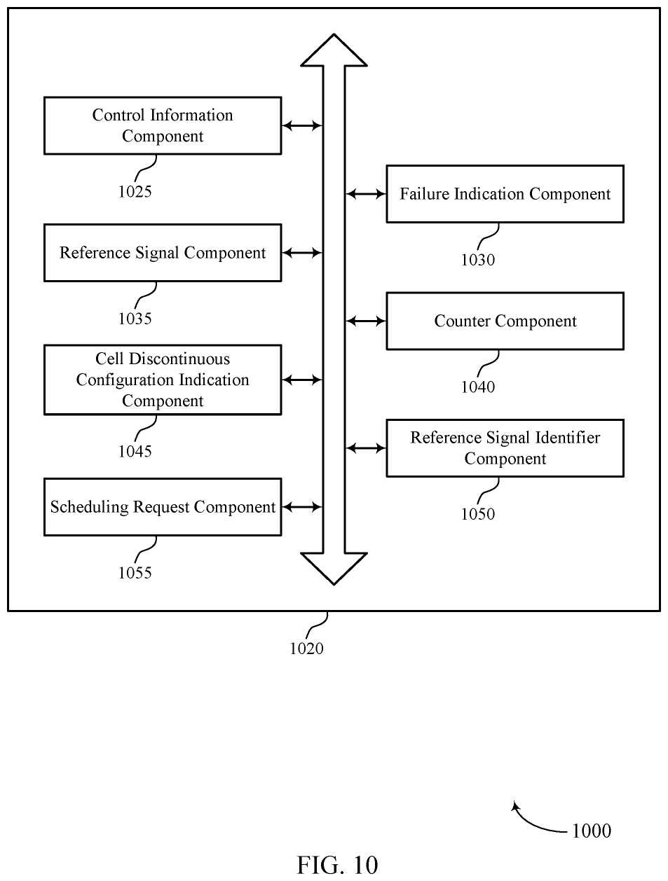

FIG. 10 shows a block diagram 1000 of a communications manager 1020 that supports autonomous UE detection of cell discontinuous operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of autonomous UE detection of cell discontinuous operation as described herein. For example, the communications manager 1020 may include a control information component 1025, a failure indication component 1030, a reference signal component 1035, a counter component 1040, a cell discontinuous configuration indication component 1045, a reference signal identifier component 1050, a scheduling request component 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The control information component 1025 is capable of, configured to, or operable to support a means for receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The failure indication component 1030 is capable of, configured to, or operable to support a means for indicating, based on the detection, a failure to receive an activation message or a deactivation message associated with a cell discontinuous operation.

In some examples, the control information component 1025 is capable of, configured to, or operable to support a means for receiving, via the information, one or more measurement value thresholds associated with the first communication, the second communication, or both, the indicating the failure based on a comparison of a set of multiple measurements to the one or more measurement value thresholds.

In some examples, the set of multiple measurements includes one or more first measurements within a first time period and one or more second measurements within a second time period and, to support indicating the failure, the failure indication component 1030 is capable of, configured to, or operable to support a means for indicating a failure to receive the activation message based on the one or more first measurements satisfying a first threshold of the one or more measurement value thresholds and the one or more second measurements failing to satisfy a second threshold of the one or more measurement value thresholds, the first threshold being associated with the set of multiple active periods and the second threshold being associated with the set of multiple non-active periods.

In some examples, the one or more first measurements are within at least one of the set of multiple active periods in accordance with the one or more first measurements satisfying the first threshold, and the one or more second measurements being within at least one of the set of multiple non-active periods in accordance with the one or more second measurements failing to satisfy the second threshold.

In some examples, the set of multiple measurements include one or more first measurements within a first time period and one or more second measurements within a second time period and, to support indicating the failure, the failure indication component 1030 is capable of, configured to, or operable to support a means for indicating a failure to receive the deactivation message based on the one or more first measurements and the one or more second measurements satisfying a threshold of the one or more measurement value thresholds.

In some examples, the reference signal identifier component 1050 is capable of, configured to, or operable to support a means for receiving a reference signal identifier of a reference signal, the set of multiple measurements being associated with the reference signal.

In some examples, the set of multiple measurements are associated with one or more reference signal received power measurements, one or more cross link interference measurements, or both.

In some examples, the control information component 1025 is capable of, configured to, or operable to support a means for receiving, via the information, a first reference signal sequence associated with the set of multiple active periods and a second reference signal sequence associated with the set of multiple non-active periods. In some examples, the reference signal component 1035 is capable of, configured to, or operable to support a means for receiving a set of multiple reference signals, the indicating the failure based on whether the set of multiple reference signals is associated with the first reference signal sequence, or the second reference signal sequence, or both.

In some examples, the reference signal component 1035 is capable of, configured to, or operable to support a means for receiving, within a first time period, one or more first reference signals of the set of multiple reference signals. In some examples, the reference signal component 1035 is capable of, configured to, or operable to support a means for receiving, within a second time period, one or more second reference signals of the set of multiple reference signals. In some examples, the failure indication component 1030 is capable of, configured to, or operable to support a means for indicating a failure to receive the activation message based on the one or more first reference signals being associated with the first reference signal sequence and the one or more second reference signals being associated with the second reference signal sequence.

In some examples, to support indicating the failure, the failure indication component 1030 is capable of, configured to, or operable to support a means for indicating a failure to receive the deactivation message based on the set of multiple reference signals being associated with the first reference signal sequence.

In some examples, the control information component 1025 is capable of, configured to, or operable to support a means for receiving, via the information, a first reference signal sequence associated with the cell discontinuous operation and a second reference signal sequence associated with an absence of the cell discontinuous operation. In some examples, the reference signal component 1035 is capable of, configured to, or operable to support a means for receiving one or more reference signals, the indicating the failure based on whether the one or more reference signals are associated with the first reference signal sequence or the second reference signal sequence.

In some examples, to support indicating the failure, the failure indication component 1030 is capable of, configured to, or operable to support a means for indicating a failure to receive the activation message based on the one or more reference signals being associated with the first reference signal sequence.

In some examples, to support indicating the failure, the failure indication component 1030 is capable of, configured to, or operable to support a means for indicating a failure to receive the deactivation message based on the one or more reference signals being associated with the second reference signal sequence.

In some examples, the control information component 1025 is capable of, configured to, or operable to support a means for receiving, via the information, a first set of resources for communication within the set of multiple active periods and a second set of resources for communication within the set of multiple non-active periods, the indicating the failure based on the first set of resources and the second set of resources.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the first set of resources. In some examples, the failure indication component 1030 is capable of, configured to, or operable to support a means for indicating a failure to receive the activation message based on a difference between one or more first failures of the one or more first scheduling requests and one or more second failures of the one or more second scheduling requests satisfying a threshold.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the second set of resources. In some examples, the failure indication component 1030 is capable of, configured to, or operable to support a means for indicating a failure to receive the deactivation message based on a difference between one or more first failures of the one or more first scheduling requests and one or more second failures of the one or more second scheduling requests satisfying a threshold.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the second set of resources based on a failure of the one or more first scheduling requests. In some examples, the failure indication component 1030 is capable of, configured to, or operable to support a means for indicating a failure to receive the activation message based on a success of the one or more second scheduling requests.

In some examples, the scheduling request component 1055 is capable of, configured to, or operable to support a means for transmitting, within a first time period, one or more first scheduling requests in accordance with the second set of resources. In some examples, the scheduling request component 1055 is capable of, configured to, or operable to support a means for transmitting, within a second time period, one or more second scheduling requests in accordance with the first set of resources based on a failure of the one or more first scheduling requests. In some examples, the failure indication component 1030 is capable of, configured to, or operable to support a means for indicating a failure to receive the deactivation message based on a success of the one or more second scheduling requests.

In some examples, the control information component 1025 is capable of, configured to, or operable to support a means for receiving, via the information, a first set of resources for communication associated with the cell discontinuous operation and a second set of resources for communication associated with an absence of the cell discontinuous operation, the indicating the failure based on the first set of resources and the second set of resources.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the first set of resources. In some examples, the failure indication component 1030 is capable of, configured to, or operable to support a means for indicating a failure to receive the activation message based on a difference between one or more first failures of the one or more first scheduling requests and one or more second failures of the one or more second scheduling requests satisfying a threshold.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the second set of resources. In some examples, the failure indication component 1030 is capable of, configured to, or operable to support a means for indicating a failure to receive the deactivation message based on a difference between one or more first failures of the one or more first scheduling requests and one or more second failures of the one or more second scheduling requests satisfying a threshold.

In some examples, the scheduling request component 1055 is capable of, configured to, or operable to support a means for transmitting, within a first time period, one or more first scheduling requests in accordance with the first set of resources. In some examples, the scheduling request component 1055 is capable of, configured to, or operable to support a means for transmitting, within a second time period, one or more second scheduling requests in accordance with the second set of resources based on a failure of the one or more first scheduling requests. In some examples, the failure indication component 1030 is capable of, configured to, or operable to support a means for indicating a failure to receive the activation message based on a success of the one or more second scheduling requests.

In some examples, the scheduling request component 1055 is capable of, configured to, or operable to support a means for transmitting, within a first time period, one or more first scheduling requests in accordance with the second set of resources. In some examples, the scheduling request component 1055 is capable of, configured to, or operable to support a means for transmitting, within a second time period, one or more second scheduling requests in accordance with the first set of resources based on a failure of the one or more first scheduling requests. In some examples, the failure indication component 1030 is capable of, configured to, or operable to support a means for indicating a failure to receive the deactivation message based on a success of the one or more second scheduling requests.

In some examples, the control information component 1025 is capable of, configured to, or operable to support a means for receiving, via the information, a counter value threshold. In some examples, the counter component 1040 is capable of, configured to, or operable to support a means for incrementing a counter based on a satisfaction of one or more criteria included in the information, the indicating the failure to receive the activation message or the deactivation message based on the counter satisfying the counter value threshold.

In some examples, to support indicating the failure, the cell discontinuous configuration indication component 1045 is capable of, configured to, or operable to support a means for indicating that an unknown cell discontinuous transmission configuration has been activated. In some examples, to support indicating the failure, the cell discontinuous configuration indication component 1045 is capable of, configured to, or operable to support a means for indicating that a cell discontinuous transmission configuration has been activated and that the cell discontinuous transmission configuration is within a set of cell discontinuous transmission configurations. In some examples, to support indicating the failure, the cell discontinuous configuration indication component 1045 is capable of, configured to, or operable to support a means for indicating that a known cell discontinuous transmission configuration has been activated.

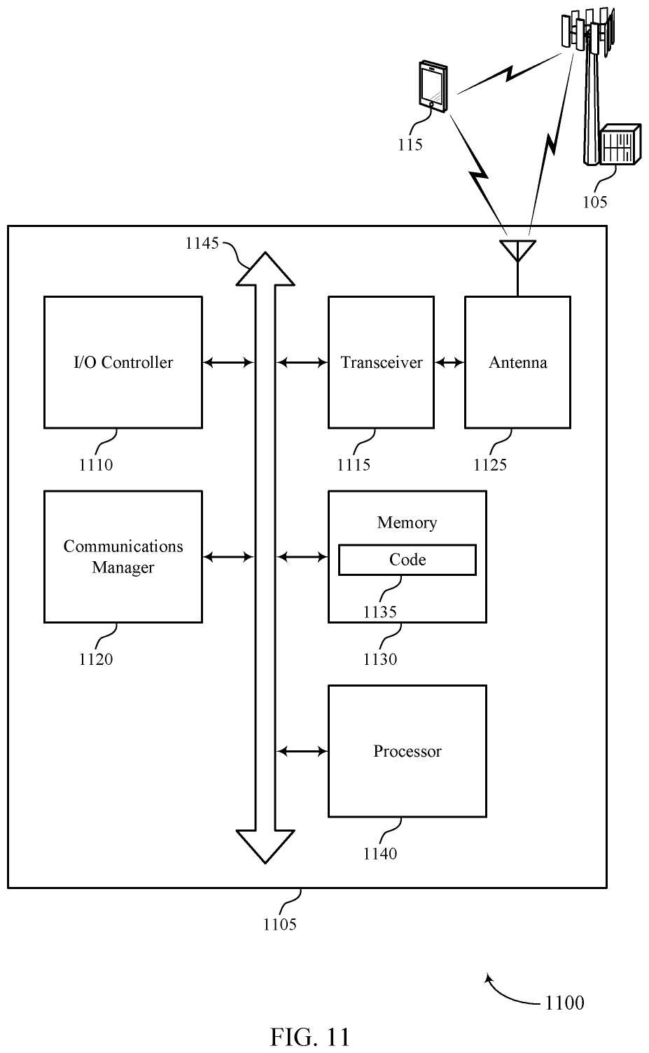

FIG. 11 shows a diagram of a system 1100 including a device 1105 that supports autonomous UE detection of cell discontinuous operation in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting autonomous UE detection of cell discontinuous operation). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. As such, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The communications manager 1120 is capable of, configured to, or operable to support a means for indicating, based on the detection, a failure to receive an activation message or a deactivation message associated with a cell discontinuous operation.

By including or configuring the communications manager 1120 in accordance with examples as described herein, the device 1105 may support techniques for improved communication reliability, reduced latency, reduced power consumption, more efficient utilization of communication resources, improved coordination between devices, and longer battery life.

In some examples, the communications manager 1120 may be configured to perform various operations (e.g., receiving, monitoring, determining, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of autonomous UE detection of cell discontinuous operation as described herein, or the at least one processor 1140 and the at least one memory 1130 may be otherwise configured to, individually or collectively, perform or support such operations.

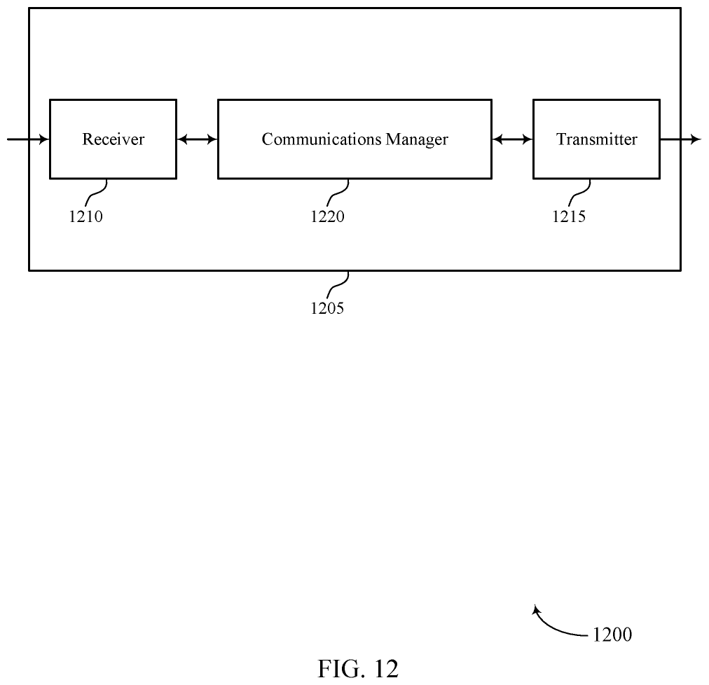

FIG. 12 shows a block diagram 1200 of a device 1205 that supports autonomous UE detection of cell discontinuous operation in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of autonomous UE detection of cell discontinuous operation as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, determining, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The communications manager 1220 is capable of, configured to, or operable to support a means for outputting an activation message or a deactivation message associated with a cell discontinuous operation. The communications manager 1220 is capable of, configured to, or operable to support a means for communicating with one or more UEs based on outputting the activation message or the deactivation message and the one or more control messages.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

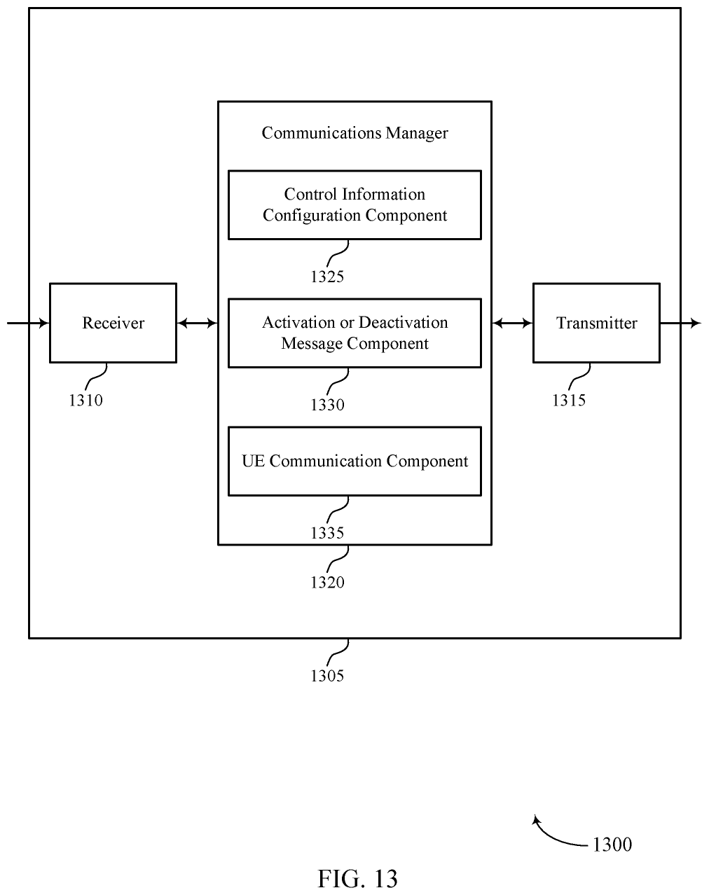

FIG. 13 shows a block diagram 1300 of a device 1305 that supports autonomous UE detection of cell discontinuous operation in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of autonomous UE detection of cell discontinuous operation as described herein. For example, the communications manager 1320 may include a control information configuration component 1325, an activation or deactivation message component 1330, a UE communication component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, determining, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The control information configuration component 1325 is capable of, configured to, or operable to support a means for outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The activation or deactivation message component 1330 is capable of, configured to, or operable to support a means for outputting an activation message or a deactivation message associated with a cell discontinuous operation. The UE communication component 1335 is capable of, configured to, or operable to support a means for communicating with one or more UEs based on outputting the activation message or the deactivation message and the one or more control messages.

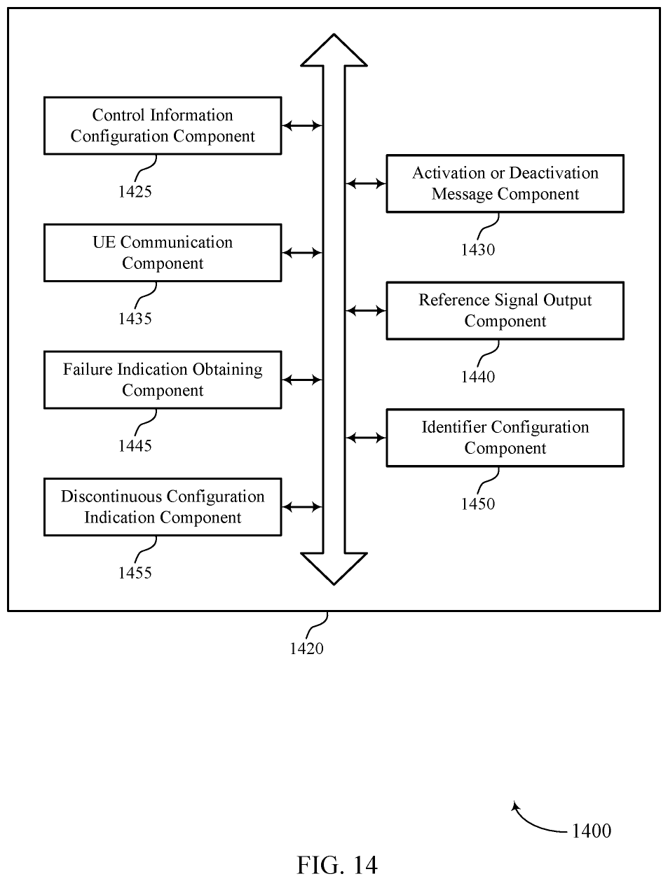

FIG. 14 shows a block diagram 1400 of a communications manager 1420 that supports autonomous UE detection of cell discontinuous operation in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of autonomous UE detection of cell discontinuous operation as described herein. For example, the communications manager 1420 may include a control information configuration component 1425, an activation or deactivation message component 1430, a UE communication component 1435, a reference signal output component 1440, a failure indication obtaining component 1445, an identifier configuration component 1450, a discontinuous configuration indication component 1455, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The control information configuration component 1425 is capable of, configured to, or operable to support a means for outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The activation or deactivation message component 1430 is capable of, configured to, or operable to support a means for outputting an activation message or a deactivation message associated with a cell discontinuous operation. The UE communication component 1435 is capable of, configured to, or operable to support a means for communicating with one or more UEs based on outputting the activation message or the deactivation message and the one or more control messages.

In some examples, the control information configuration component 1425 is capable of, configured to, or operable to support a means for outputting, via the information, one or more measurement value thresholds associated with the first communication, the second communication, or both, the communicating based on the one or more measurement value thresholds.

In some examples, the identifier configuration component 1450 is capable of, configured to, or operable to support a means for outputting a reference signal identifier of a reference signal, a set of multiple measurements by the one or more UEs being associated with the reference signal.

In some examples, the one or more measurement value thresholds are associated with one or more reference signal received power measurements, one or more cross link interference measurements, or both.

In some examples, the control information configuration component 1425 is capable of, configured to, or operable to support a means for outputting, via the information, a first reference signal sequence associated with the set of multiple active periods and a second reference signal sequence associated with the set of multiple non-active periods. In some examples, the reference signal output component 1440 is capable of, configured to, or operable to support a means for outputting a set of multiple reference signals, the communicating based on whether the set of multiple reference signals is associated with the first reference signal sequence, or the second reference signal sequence, or both.

In some examples, the control information configuration component 1425 is capable of, configured to, or operable to support a means for outputting, via the information, a first reference signal sequence associated with the cell discontinuous operation and a second reference signal sequence associated with an absence of the cell discontinuous operation. In some examples, the reference signal output component 1440 is capable of, configured to, or operable to support a means for outputting one or more reference signals, the communicating based on whether the one or more reference signals are associated with the first reference signal sequence or the second reference signal sequence.

In some examples, the control information configuration component 1425 is capable of, configured to, or operable to support a means for outputting, via the information, a first set of resources for communication within the set of multiple active periods and a second set of resources for communication within the set of multiple non-active periods, the communicating based on the first set of resources and the second set of resources.

In some examples, the control information configuration component 1425 is capable of, configured to, or operable to support a means for outputting, via the information, a first set of resources for communication associated with the cell discontinuous operation and a second set of resources for communication associated with an absence of the cell discontinuous operation, the communicating based on the first set of resources and the second set of resources.

In some examples, the control information configuration component 1425 is capable of, configured to, or operable to support a means for outputting, via the information, a counter value threshold, the communicating based on outputting the counter value threshold.

In some examples, the failure indication obtaining component 1445 is capable of, configured to, or operable to support a means for obtaining, from the one or more UEs, an indication of a failure to receive the activation message or the deactivation message associated with the cell discontinuous operation based on outputting the one or more control messages.

In some examples, the discontinuous configuration indication component 1455 is capable of, configured to, or operable to support a means for obtaining an indication that an unknown cell discontinuous transmission configuration has been activated. In some examples, the discontinuous configuration indication component 1455 is capable of, configured to, or operable to support a means for obtaining an indication that a cell discontinuous transmission configuration has been activated and that the cell discontinuous transmission configuration is within a set of cell discontinuous transmission configurations. In some examples, the discontinuous configuration indication component 1455 is capable of, configured to, or operable to support a means for obtaining an indication that a known cell discontinuous transmission configuration has been activated.

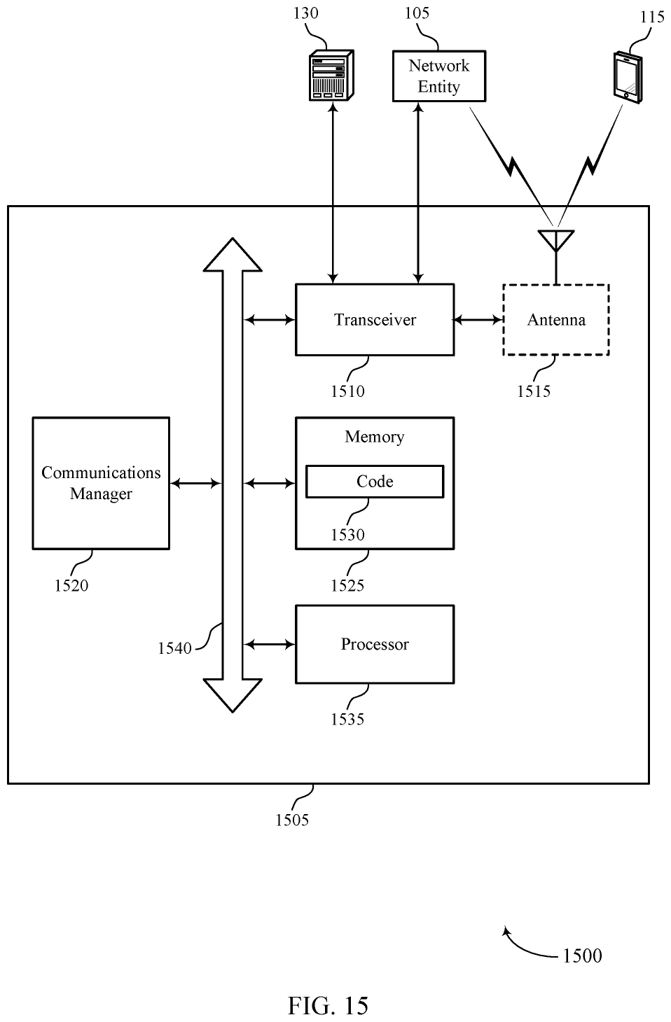

FIG. 15 shows a diagram of a system 1500 including a device 1505 that supports autonomous UE detection of cell discontinuous operation in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may contain, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting autonomous UE detection of cell discontinuous operation). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525). In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. As such, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The communications manager 1520 is capable of, configured to, or operable to support a means for outputting an activation message or a deactivation message associated with a cell discontinuous operation. The communications manager 1520 is capable of, configured to, or operable to support a means for communicating with one or more UEs based on outputting the activation message or the deactivation message and the one or more control messages.

By including or configuring the communications manager 1520 in accordance with examples as described herein, the device 1505 may support techniques for improved communication reliability, reduced latency, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, determining, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of autonomous UE detection of cell discontinuous operation as described herein, or the at least one processor 1535 and the at least one memory 1525 may be otherwise configured to, individually or collectively, perform or support such operations.

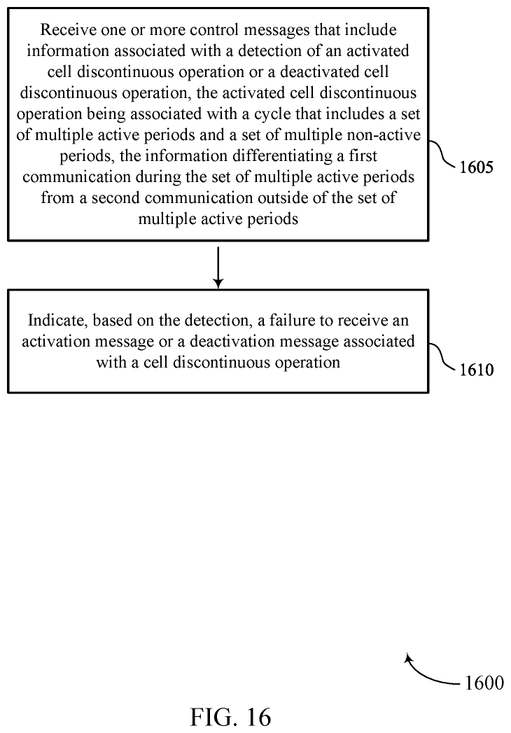

FIG. 16 shows a flowchart illustrating a method 1600 that supports autonomous UE detection of cell discontinuous operation in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The operations of block 1605 may be performed in accordance with examples as disclosed herein. In some examples, aspects of the operations of 1605 may be performed by a control information component 1025 as described with reference to FIG. 10.

At 1610, the method may include indicating, based on the detection, a failure to receive an activation message or a deactivation message associated with a cell discontinuous operation. The operations of block 1610 may be performed in accordance with examples as disclosed herein. In some examples, aspects of the operations of 1610 may be performed by a failure indication component 1030 as described with reference to FIG. 10.

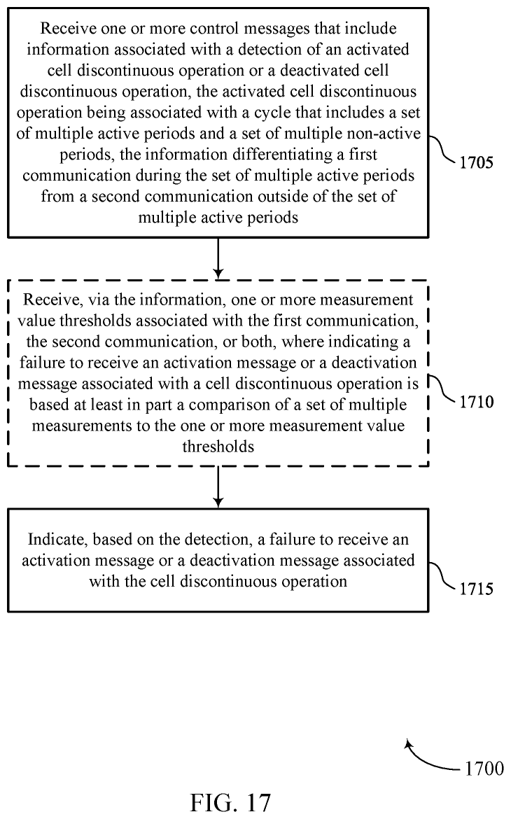

FIG. 17 shows a flowchart illustrating a method 1700 that supports autonomous UE detection of cell discontinuous operation in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The operations of block 1705 may be performed in accordance with examples as disclosed herein. In some examples, aspects of the operations of 1705 may be performed by a control information component 1025 as described with reference to FIG. 10.

At 1710, the method may include receiving, via the information, one or more measurement value thresholds associated with the first communication, the second communication, or both, where indicating a failure to receive an activation message or a deactivation message associated with a cell discontinuous operation is based on a comparison of a set of multiple measurements to the one or more measurement value thresholds. The operations of block 1710 may be performed in accordance with examples as disclosed herein. In some examples, aspects of the operations of 1710 may be performed by a control information component 1025 as described with reference to FIG. 10.

At 1715, the method may include indicating, based on the detection, the failure to receive the activation message or the deactivation message associated with a cell discontinuous operation. The operations of block 1715 may be performed in accordance with examples as disclosed herein. In some examples, aspects of the operations of 1715 may be performed by a failure indication component 1030 as described with reference to FIG. 10.

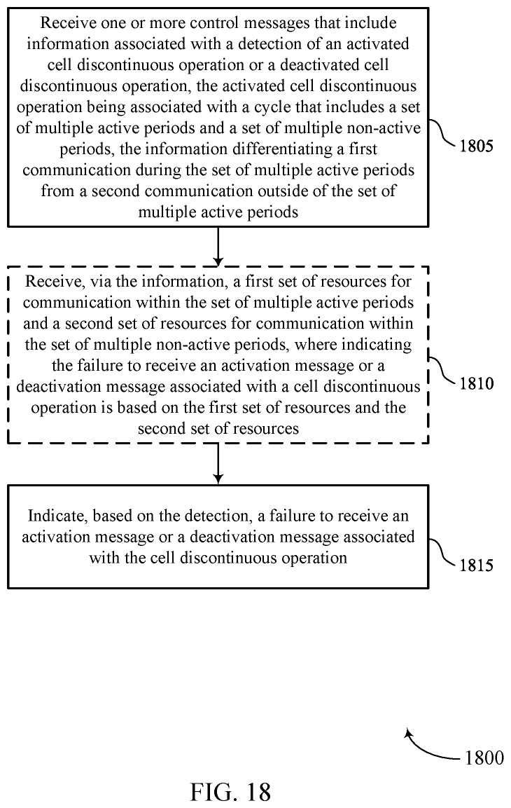

FIG. 18 shows a flowchart illustrating a method 1800 that supports autonomous UE detection of cell discontinuous operation in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving one or more control messages that include information associated with a detection of an activated cell discontinuous operation or a deactivated cell discontinuous operation, the activated cell discontinuous operation being associated with a cycle that includes a set of multiple active periods and a set of multiple non-active periods, the information differentiating a first communication during the set of multiple active periods from a second communication outside of the set of multiple active periods. The operations of block 1805 may be performed in accordance with examples as disclosed herein. In some examples, aspects of the operations of 1805 may be performed by a control information component 1025 as described with reference to FIG. 10.

At 1810, the method may include receiving, via the information, a first set of resources for communication within the set of multiple active periods and a second set of resources for communication within the set of multiple non-active periods, where indicating a failure to receive an activation message or a deactivation message associated with a cell discontinuous operation is based on the first set of resources and the second set of resources. The operations of block 1810 may be performed in accordance with examples as disclosed herein. In some examples, aspects of the operations of 1810 may be performed by a control information component 1025 as described with reference to FIG. 10.

At 1815, the method may include indicating, based on the detection, the failure to receive the activation message or the deactivation message associated with a cell discontinuous operation. The operations of block 1815 may be performed in accordance with examples as disclosed herein. In some examples, aspects of the operations of 1815 may be performed by a failure indication component 1030 as described with reference to FIG. 10.

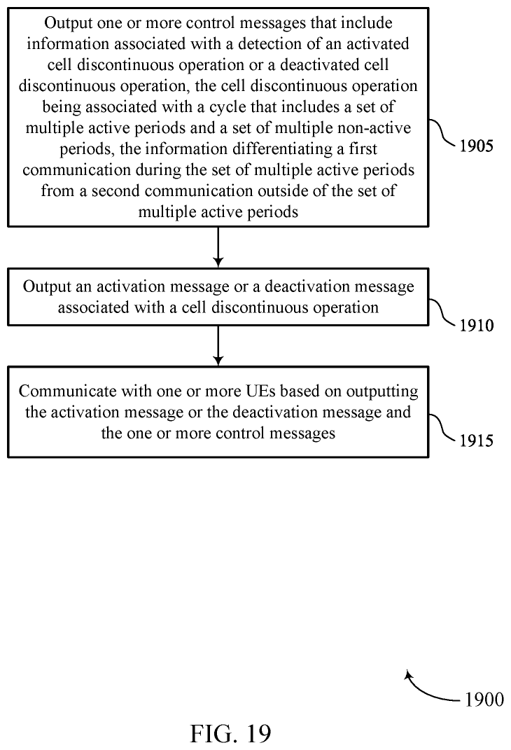

FIG. 19 shows a flowchart illustrating a method 1900 that supports autonomous UE detection of cell discontinuous operation in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting one or more control messages that include information associated with a detection of an activated cell discontinuous operation or a deactivated cell discontinuous operation, the cell discontinuous operation being associated with a cycle that includes a set of multiple active periods and a set of multiple non-active periods, the information differentiating a first communication during the set of multiple active periods from a second communication outside of the set of multiple active periods. The operations of block 1905 may be performed in accordance with examples as disclosed herein. In some examples, aspects of the operations of 1905 may be performed by a control information configuration component 1425 as described with reference to FIG. 14.

At 1910, the method may include outputting an activation message or a deactivation message associated with a cell discontinuous operation. The operations of block 1910 may be performed in accordance with examples as disclosed herein. In some examples, aspects of the operations of 1910 may be performed by an activation or deactivation message component 1430 as described with reference to FIG. 14.

At 1915, the method may include communicating with one or more UEs based on outputting the activation message or the deactivation message and the one or more control messages. The operations of block 1915 may be performed in accordance with examples as disclosed herein. In some examples, aspects of the operations of 1915 may be performed by a UE communication component 1435 as described with reference to FIG. 14.

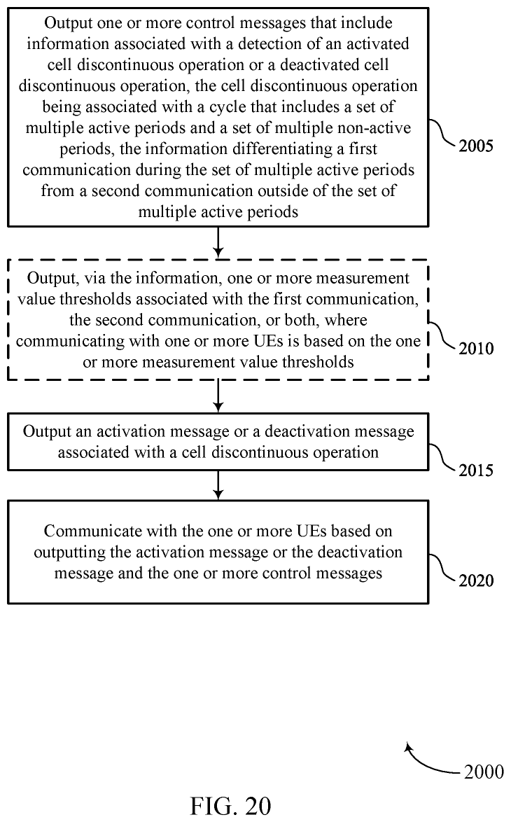

FIG. 20 shows a flowchart illustrating a method 2000 that supports autonomous UE detection of cell discontinuous operation in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include outputting one or more control messages that include information associated with a detection of an activated cell discontinuous operation or a deactivated cell discontinuous operation, the cell discontinuous operation being associated with a cycle that includes a set of multiple active periods and a set of multiple non-active periods, the information differentiating a first communication during the set of multiple active periods from a second communication outside of the set of multiple active periods. The operations of block 2005 may be performed in accordance with examples as disclosed herein. In some examples, aspects of the operations of 2005 may be performed by a control information configuration component 1425 as described with reference to FIG. 14.

At 2010, the method may include outputting, via the information, one or more measurement value thresholds associated with the first communication, the second communication, or both, where communicating with one or more UEs is based on the one or more measurement value thresholds. The operations of block 2010 may be performed in accordance with examples as disclosed herein. In some examples, aspects of the operations of 2010 may be performed by a control information configuration component 1425 as described with reference to FIG. 14.

At 2015, the method may include outputting an activation message or a deactivation message associated with a cell discontinuous operation. The operations of block 2015 may be performed in accordance with examples as disclosed herein. In some examples, aspects of the operations of 2015 may be performed by an activation or deactivation message component 1430 as described with reference to FIG. 14.

At 2020, the method may include communicating with the one or more UEs based on outputting the activation message or the deactivation message and the one or more control messages. The operations of block 2020 may be performed in accordance with examples as disclosed herein. In some examples, aspects of the operations of 2020 may be performed by a UE communication component 1435 as described with reference to FIG. 14.

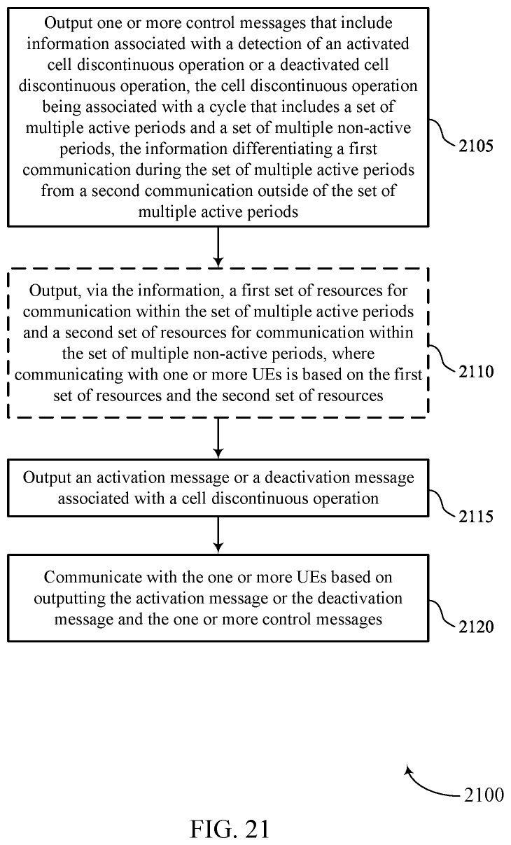

FIG. 21 shows a flowchart illustrating a method 2100 that supports autonomous UE detection of cell discontinuous operation in accordance with aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include outputting one or more control messages that include information associated with a detection of an activated cell discontinuous operation or a deactivated cell discontinuous operation, the cell discontinuous operation being associated with a cycle that includes a set of multiple active periods and a set of multiple non-active periods, the information differentiating a first communication during the set of multiple active periods from a second communication outside of the set of multiple active periods. The operations of block 2105 may be performed in accordance with examples as disclosed herein. In some examples, aspects of the operations of 2105 may be performed by a control information configuration component 1425 as described with reference to FIG. 14.

At 2110, the method may include outputting, via the information, a first set of resources for communication within the set of multiple active periods and a second set of resources for communication within the set of multiple non-active periods, where communicating with one or more UEs is based on the first set of resources and the second set of resources. The operations of block 2110 may be performed in accordance with examples as disclosed herein. In some examples, aspects of the operations of 2110 may be performed by a control information configuration component 1425 as described with reference to FIG. 14.

At 2115, the method may include outputting an activation message or a deactivation message associated with a cell discontinuous operation. The operations of block 2115 may be performed in accordance with examples as disclosed herein. In some examples, aspects of the operations of 2115 may be performed by an activation or deactivation message component 1430 as described with reference to FIG. 14.

At 2120, the method may include communicating with the one or more UEs based on outputting the activation message or the deactivation message and the one or more control messages. The operations of block 2120 may be performed in accordance with examples as disclosed herein. In some examples, aspects of the operations of 2120 may be performed by a UE communication component 1435 as described with reference to FIG. 14.

The following provides an overview of examples of the present disclosure:
Aspect 1: An apparatus for wireless communications at a UE, comprising one or more memories and one or more processors coupled with the one or more memories and configured to cause the UE to: receive one or more control messages that include information associated with a detection of an activated cell discontinuous operation or a deactivated cell discontinuous operation, the activated cell discontinuous operation being associated with a cycle that includes a plurality of active periods and a plurality of non-active periods, the information differentiating a first communication during the plurality of active periods from a second communication outside of the plurality of active periods; and indicate, based at least in part on the detection, a failure to receive an activation message or a deactivation message associated with a cell discontinuous operation.
Aspect 2: The apparatus of aspect 1, the one or more processors further configured to cause the UE to: receive, via the information, one or more measurement value thresholds associated with the first communication, the second communication, or both, the indicating the failure based at least in part on a comparison of a plurality of measurements to the one or more measurement value thresholds.
Aspect 3: The apparatus of aspect 2, wherein the plurality of measurements comprises one or more first measurements within a first time period and the indicating the failure comprises: indicate a failure to receive the activation message based at least in part on the one or more first measurements satisfying a first threshold of the one or more measurement value thresholds, the first threshold being associated with the plurality of active periods.
Aspect 4: The apparatus of any of aspects 1 through 3, wherein the plurality of measurements comprises one or more second measurements within a second time period and the indicating the failure comprises: indicate a failure to receive the activation message based at least in part on the one or more second measurements failing to satisfy a second threshold of the one or more measurement value thresholds, the second threshold being associated with the plurality of non-active periods.
Aspect 5: The apparatus of any of aspects 3 through 4, wherein the one or more first measurements are within at least one of the plurality of active periods in accordance with the one or more first measurements satisfying the first threshold, and the one or more second measurements being within at least one of the plurality of non-active periods in accordance with the one or more second measurements failing to satisfy the second threshold.
Aspect 6: The apparatus of any of aspects 1 through 5, wherein the plurality of measurements comprise one or more first measurements within a first time period and one or more second measurements within a second time period and the indicating the failure comprises: indicate a failure to receive the deactivation message based at least in part on the one or more first measurements and the one or more second measurements satisfying a threshold of the one or more measurement value thresholds.
Aspect 7: The apparatus of any of aspects 1 through 6, the one or more processors further configured to cause the UE to: receive a reference signal identifier of a reference signal, the plurality of measurements being associated with the reference signal.
Aspect 8: The apparatus of any of aspects 1 through 7, wherein the plurality of measurements are associated with one or more reference signal received power measurements, one or more cross link interference measurements, or both.
Aspect 9: The apparatus of any of aspects 1 through 8, the one or more processors further configured to cause the UE to: receive, via the information, a first reference signal sequence associated with the plurality of active periods and a second reference signal sequence associated with the plurality of non-active periods; and receive a plurality of reference signals, the indicating the failure based at least in part on whether the plurality of reference signals is associated with the first reference signal sequence, or the second reference signal sequence, or both.
Aspect 10: The apparatus any of aspects 1 through 9, the one or more processors further configured to cause the UE to: receive, within a first time period, one or more first reference signals of the plurality of reference signals; receive, within a second time period, one or more second reference signals of the plurality of reference signals; and indicate a failure to receive the activation message based at least in part on the one or more first reference signals being associated with the first reference signal sequence and the one or more second reference signals being associated with the second reference signal sequence.
Aspect 11: The apparatus any of aspects 1 through 10, wherein the indicating the failure comprises: indicate a failure to receive the deactivation message based at least in part on the plurality of reference signals being associated with the first reference signal sequence.
Aspect 12: The apparatus of any of aspects 1 through 11, the one or more processors further configured to cause the UE to: receive, via the information, a first reference signal sequence associated with the cell discontinuous operation and a second reference signal sequence associated with an absence of the cell discontinuous operation; and receive one or more reference signals, the indicating the failure based at least in part on whether the one or more reference signals are associated with the first reference signal sequence or the second reference signal sequence.
Aspect 13: The apparatus of aspect 12, wherein the indicating the failure comprises: indicate a failure to receive the activation message based at least in part on the one or more reference signals being associated with the first reference signal sequence.
Aspect 14: The apparatus of aspect 12, wherein the indicating the failure comprises: indicate a failure to receive the deactivation message based at least in part on the one or more reference signals being associated with the second reference signal sequence.
Aspect 15: The apparatus of any of aspects 1 through 14, the one or more processors further configured to cause the UE to: receive, via the information, a first set of resources for communication within the plurality of active periods and a second set of resources for communication within the plurality of non-active periods, the indicating the failure based at least in part on the first set of resources and the second set of resources.
Aspect 16: The apparatus of aspect 15, the one or more processors further configured to cause the UE to: transmit, within a first time period, one or more first scheduling requests in accordance with the first set of resources; transmit, within a second time period, one or more second scheduling requests in accordance with the first set of resources; and indicate a failure to receive the activation message based at least in part on a difference between one or more first failures of the one or more first scheduling requests and one or more second failures of the one or more second scheduling requests satisfying a threshold.
Aspect 17: The apparatus of any of aspects 15 through 16, the one or more processors further configured to cause the UE to: transmit, within a first time period, one or more first scheduling requests in accordance with the first set of resources; transmit, within a second time period, one or more second scheduling requests in accordance with the second set of resources; and indicate a failure to receive the deactivation message based at least in part on a difference between one or more first failures of the one or more first scheduling requests and one or more second failures of the one or more second scheduling requests satisfying a threshold.
Aspect 18: The apparatus of any of aspects 15 through 17, the one or more processors further configured to cause the UE to: transmit, within a first time period, one or more first scheduling requests in accordance with the first set of resources; transmit, within a second time period, one or more second scheduling requests in accordance with the second set of resources based at least in part on a failure of the one or more first scheduling requests; and indicate a failure to receive the activation message based at least in part on a success of the one or more second scheduling requests.
Aspect 19: The apparatus of any of aspects 1 through 18, the one or more processors further configured to cause the UE to: transmit, within a first time period, one or more first scheduling requests in accordance with the second set of resources; transmit, within a second time period, one or more second scheduling requests in accordance with the first set of resources based at least in part on a failure of the one or more first scheduling requests; and indicate a failure to receive the deactivation message based at least in part on a success of the one or more second scheduling requests.
Aspect 20: The apparatus of any of aspects 1 through 19, the one or more processors further configured to cause the UE to: receive, via the information, a first set of resources for communication associated with the cell discontinuous operation and a second set of resources for communication associated with an absence of the cell discontinuous operation, the indicating the failure based at least in part on the first set of resources and the second set of resources.
Aspect 21: The apparatus of aspect 20, the one or more processors further configured to cause the UE to: transmit, within a first time period, one or more first scheduling requests in accordance with the first set of resources; transmit, within a second time period, one or more second scheduling requests in accordance with the first set of resources; and indicate a failure to receive the activation message based at least in part on a difference between one or more first failures of the one or more first scheduling requests and one or more second failures of the one or more second scheduling requests satisfying a threshold.
Aspect 22: The apparatus of any of aspects 20 through 21, the one or more processors further configured to cause the UE to: transmit, within a first time period, one or more first scheduling requests in accordance with the first set of resources; transmit, within a second time period, one or more second scheduling requests in accordance with the second set of resources; and indicate a failure to receive the deactivation message based at least in part on a difference between one or more first failures of the one or more first scheduling requests and one or more second failures of the one or more second scheduling requests satisfying a threshold.
Aspect 23: The apparatus of any of aspects 20 through 22, the one or more processors further configured to cause the UE to: transmit, within a first time period, one or more first scheduling requests in accordance with the first set of resources; transmit, within a second time period, one or more second scheduling requests in accordance with the second set of resources based at least in part on a failure of the one or more first scheduling requests; and indicate a failure to receive the activation message based at least in part on a success of the one or more second scheduling requests.
Aspect 24: The apparatus of any of aspects 20 through 23, the one or more processors further configured to cause the UE to: transmit, within a first time period, one or more first scheduling requests in accordance with the second set of resources; transmit, within a second time period, one or more second scheduling requests in accordance with the first set of resources based at least in part on a failure of the one or more first scheduling requests; and indicate a failure to receive the deactivation message based at least in part on a success of the one or more second scheduling requests.
Aspect 25: The apparatus of any of aspects 1 through 24, the one or more processors further configured to cause the UE to: receive, via the information, a counter value threshold; and incrementing a counter based at least in part on based at least in part on a satisfaction of one or more criteria included in the information, the indicating the failure to receive the activation message or the deactivation message based at least in part on the counter satisfying the counter value threshold.
Aspect 26: The apparatus of any of aspects 1 through 25, wherein the indicating the failure comprises: indicate that an unknown cell discontinuous transmission configuration has been activated; indicate that a cell discontinuous transmission configuration has been activated and that the cell discontinuous transmission configuration is within a set of cell discontinuous transmission configurations; or indicate that a known cell discontinuous transmission configuration has been activated.
Aspect 27: A method for wireless communications at a UE, comprising: receiving one or more control messages that include information associated with a detection of an activated cell discontinuous operation or a deactivated cell discontinuous operation, the activated cell discontinuous operation being associated with a cycle that includes a plurality of active periods and a plurality of non-active periods, the information differentiating a first communication during the plurality of active periods from a second communication outside of the plurality of active periods; and indicating, based at least in part on the detection, a failure to receive an activation message or a deactivation message associated with a cell discontinuous operation.
Aspect 28: The method of aspect 27, further comprising: receiving, via the information, one or more measurement value thresholds associated with the first communication, the second communication, or both, the indicating the failure based at least in part on a comparison of a plurality of measurements to the one or more measurement value thresholds.
Aspect 29: The method of aspect 28, wherein the plurality of measurements comprises one or more first measurements within a first time period and the indicating the failure comprises: indicating a failure to receive the activation message based at least in part on the one or more first measurements satisfying a first threshold of the one or more measurement value thresholds, the first threshold being associated with the plurality of active periods.
Aspect 30: The method of any of aspects 27 through 29, wherein the plurality of measurements comprises one or more second measurements within a second time period and the indicating the failure comprises: indicating a failure to receive the activation message based at least in part on the one or more second measurements failing to satisfy a second threshold of the one or more measurement value thresholds, the second threshold being associated with the plurality of non-active periods.
Aspect 31: The method of any of aspects 27 through 30, wherein the one or more first measurements are within at least one of the plurality of active periods in accordance with the one or more first measurements satisfying the first threshold, and the one or more second measurements being within at least one of the plurality of non-active periods in accordance with the one or more second measurements failing to satisfy the second threshold.
Aspect 32: The method of any of aspects 27 through 31, wherein the plurality of measurements comprise one or more first measurements within a first time period and one or more second measurements within a second time period and the indicating the failure comprises: indicating a failure to receive the deactivation message based at least in part on the one or more first measurements and the one or more second measurements satisfying a threshold of the one or more measurement value thresholds.
Aspect 33: The method of any of aspects 27 through 32, further comprising: receiving a reference signal identifier of a reference signal, the plurality of measurements being associated with the reference signal.
Aspect 34: The method of any of aspects 27 through 33, wherein the plurality of measurements are associated with one or more reference signal received power measurements, one or more cross link interference measurements, or both.
Aspect 35: The method of any of aspects 27 through 34, further comprising: receiving, via the information, a first reference signal sequence associated with the plurality of active periods and a second reference signal sequence associated with the plurality of non-active periods; and receiving a plurality of reference signals, the indicating the failure based at least in part on whether the plurality of reference signals is associated with the first reference signal sequence, or the second reference signal sequence, or both.
Aspect 36: The method of aspect 35, further comprising: receiving, within a first time period, one or more first reference signals of the plurality of reference signals; receiving, within a second time period, one or more second reference signals of the plurality of reference signals; and indicating a failure to receive the activation message based at least in part on the one or more first reference signals being associated with the first reference signal sequence and the one or more second reference signals being associated with the second reference signal sequence.
Aspect 37: The method of any of aspects 35 through 36, wherein the indicating the failure comprises: indicating a failure to receive the deactivation message based at least in part on the plurality of reference signals being associated with the first reference signal sequence.
Aspect 38: The method of any of aspects 27 through 37, further comprising: receiving, via the information, a first reference signal sequence associated with the cell discontinuous operation and a second reference signal sequence associated with an absence of the cell discontinuous operation; and receiving one or more reference signals, the indicating the failure based at least in part on whether the one or more reference signals are associated with the first reference signal sequence or the second reference signal sequence.
Aspect 39: The method of aspect 38, wherein the indicating the failure comprises: indicating a failure to receive the activation message based at least in part on the one or more reference signals being associated with the first reference signal sequence.
Aspect 40: The method of any of aspects 38 through 39, wherein the indicating the failure comprises: indicating a failure to receive the deactivation message based at least in part on the one or more reference signals being associated with the second reference signal sequence.
Aspect 41: The method of any of aspects 27 through 40, further comprising: receiving, via the information, a first set of resources for communication within the plurality of active periods and a second set of resources for communication within the plurality of non-active periods, the indicating the failure based at least in part on the first set of resources and the second set of resources.
Aspect 42: The method of aspect 41, further comprising: transmitting, within a first time period, one or more first scheduling requests in accordance with the first set of resources; transmitting, within a second time period, one or more second scheduling requests in accordance with the first set of resources; and indicating a failure to receive the activation message based at least in part on a difference between one or more first failures of the one or more first scheduling requests and one or more second failures of the one or more second scheduling requests satisfying a threshold.
Aspect 43: The method of any of aspects 41 through 42, further comprising: transmitting, within a first time period, one or more first scheduling requests in accordance with the first set of resources; transmitting, within a second time period, one or more second scheduling requests in accordance with the second set of resources; and indicating a failure to receive the deactivation message based at least in part on a difference between one or more first failures of the one or more first scheduling requests and one or more second failures of the one or more second scheduling requests satisfying a threshold.
Aspect 44: The method of any of aspects 41 through 43, further comprising: transmitting, within a first time period, one or more first scheduling requests in accordance with the first set of resources; transmitting, within a second time period, one or more second scheduling requests in accordance with the second set of resources based at least in part on a failure of the one or more first scheduling requests; and indicating a failure to receive the activation message based at least in part on a success of the one or more second scheduling requests.
Aspect 45: The method of any of aspects 41 through 44, further comprising: transmitting, within a first time period, one or more first scheduling requests in accordance with the second set of resources; transmitting, within a second time period, one or more second scheduling requests in accordance with the first set of resources based at least in part on a failure of the one or more first scheduling requests; and indicating a failure to receive the deactivation message based at least in part on a success of the one or more second scheduling requests.
Aspect 46: The method of any of aspects 27 through 45, further comprising: receiving, via the information, a first set of resources for communication associated with the cell discontinuous operation and a second set of resources for communication associated with an absence of the cell discontinuous operation, the indicating the failure based at least in part on the first set of resources and the second set of resources.
Aspect 47: The method of aspect 46, further comprising: transmitting, within a first time period, one or more first scheduling requests in accordance with the first set of resources; transmitting, within a second time period, one or more second scheduling requests in accordance with the first set of resources; and indicating a failure to receive the activation message based at least in part on a difference between one or more first failures of the one or more first scheduling requests and one or more second failures of the one or more second scheduling requests satisfying a threshold.
Aspect 48: The method of any of aspects 46 through 47, further comprising: transmitting, within a first time period, one or more first scheduling requests in accordance with the first set of resources; transmitting, within a second time period, one or more second scheduling requests in accordance with the second set of resources; and indicating a failure to receive the deactivation message based at least in part on a difference between one or more first failures of the one or more first scheduling requests and one or more second failures of the one or more second scheduling requests satisfying a threshold.
Aspect 49: The method of any of aspects 46 through 48, further comprising: transmitting, within a first time period, one or more first scheduling requests in accordance with the first set of resources; transmitting, within a second time period, one or more second scheduling requests in accordance with the second set of resources based at least in part on a failure of the one or more first scheduling requests; and indicating a failure to receive the activation message based at least in part on a success of the one or more second scheduling requests.
Aspect 50: The method of any of aspects 46 through 49, further comprising: transmitting, within a first time period, one or more first scheduling requests in accordance with the second set of resources; transmitting, within a second time period, one or more second scheduling requests in accordance with the first set of resources based at least in part on a failure of the one or more first scheduling requests; and indicating a failure to receive the deactivation message based at least in part on a success of the one or more second scheduling requests.
Aspect 51: The method of any of aspects 27 through 50, further comprising: receiving, via the information, a counter value threshold; and incrementing a counter based at least in part on based at least in part on a satisfaction of one or more criteria included in the information, the indicating the failure to receive the activation message or the deactivation message based at least in part on the counter satisfying the counter value threshold.
Aspect 52: The method of any of aspects 27 through 51, wherein the indicating the failure comprises: indicating that an unknown cell discontinuous transmission configuration has been activated; indicating that a cell discontinuous transmission configuration has been activated and that the cell discontinuous transmission configuration is within a set of cell discontinuous transmission configurations; or indicating that a known cell discontinuous transmission configuration has been activated.
Aspect 53: An apparatus for wireless communications at a network entity, comprising one or more memories and one or more processors coupled with the one or more memories and configured to cause the network entity to: output one or more control messages that include information associated with a detection of an activated cell discontinuous operation or a deactivated cell discontinuous operation, the activated cell discontinuous operation being associated with a cycle that includes a plurality of active periods and a plurality of non-active periods, the information differentiating a first communication during the plurality of active periods from a second communication outside of the plurality of active periods; output an activation message or a deactivation message associated with a cell discontinuous operation; and communicating with one or more user equipments (UEs) based at least in part on outputting the activation message or the deactivation message and the one or more control messages.
Aspect 54: The apparatus of aspect 53, the one or more processors further configured to cause the network entity to: output, via the information, one or more measurement value thresholds associated with the first communication, the second communication, or both, the communicating based at least in part on the one or more measurement value thresholds.
Aspect 55: The apparatus of aspect 54, the one or more processors further configured to cause the network entity to: output a reference signal identifier of a reference signal, a plurality of measurements by the one or more UEs being associated with the reference signal.
Aspect 56: The apparatus of any of aspects 54 through 55, wherein the one or more measurement value thresholds are associated with one or more reference signal received power measurements, one or more cross link interference measurements, or both.
Aspect 57: The apparatus of any of aspects 53 through 56, the one or more processors further configured to cause the network entity to: output, via the information, a first reference signal sequence associated with the plurality of active periods and a second reference signal sequence associated with the plurality of non-active periods; and output a plurality of reference signals, the communicating based at least in part on whether the plurality of reference signals is associated with the first reference signal sequence, or the second reference signal sequence, or both.
Aspect 58: The apparatus of any of aspects 53 through 57, the one or more processors further configured to cause the network entity to: output, via the information, a first reference signal sequence associated with the cell discontinuous operation and a second reference signal sequence associated with an absence of the cell discontinuous operation; and output one or more reference signals, the communicating based at least in part on whether the one or more reference signals are associated with the first reference signal sequence or the second reference signal sequence.
Aspect 59: The apparatus of any of aspects 53 through 58, the one or more processors further configured to cause the network entity to: output, via the information, a first set of resources for communication within the plurality of active periods and a second set of resources for communication within the plurality of non-active periods, the communicating based at least in part on the first set of resources and the second set of resources.
Aspect 60: The apparatus of any of aspects 53 through 59, the one or more processors further configured to cause the network entity to: output, via the information, a first set of resources for communication associated with the cell discontinuous operation and a second set of resources for communication associated with an absence of the cell discontinuous operation, the communicating based at least in part on the first set of resources and the second set of resources.
Aspect 61: The apparatus of any of aspects 53 through 60, the one or more processors further configured to cause the network entity to: output, via the information, a counter value threshold, the communicating based at least in part on outputting the counter value threshold.
Aspect 62: The apparatus of any of aspects 53 through 61, the one or more processors further configured to cause the network entity to: obtaining, from the one or more UEs, an indication of a failure to receive the activation message or the deactivation message associated with the cell discontinuous operation based at least in part on outputting the one or more control messages.
Aspect 63: The apparatus of aspect 62, the one or more processors further configured to cause the network entity to: obtaining an indication that an unknown cell discontinuous transmission configuration has been activated; obtaining an indication that a cell discontinuous transmission configuration has been activated and that the cell discontinuous transmission configuration is within a set of cell discontinuous transmission configurations; or obtaining an indication that a known cell discontinuous transmission configuration has been activated.
Aspect 64: A method for wireless communications at a network entity, comprising: outputting one or more control messages that include information associated with a detection of an activated cell discontinuous operation or a deactivated cell discontinuous operation, the activated cell discontinuous operation being associated with a cycle that includes a plurality of active periods and a plurality of non-active periods, the information differentiating a first communication during the plurality of active periods from a second communication outside of the plurality of active periods; outputting an activation message or a deactivation message associated with a cell discontinuous operation; and communicating with one or more UEs based at least in part on outputting the activation message or the deactivation message and the one or more control messages.
Aspect 65: The method of aspect 64, further comprising: outputting, via the information, one or more measurement value thresholds associated with the first communication, the second communication, or both, the communicating based at least in part on the one or more measurement value thresholds.
Aspect 66: The method of aspect 65, further comprising: outputting a reference signal identifier of a reference signal, a plurality of measurements by the one or more UEs being associated with the reference signal.
Aspect 67: The method of any of aspects 65 through 66, wherein the one or more measurement value thresholds are associated with one or more reference signal received power measurements, one or more cross link interference measurements, or both.
Aspect 68: The method of any of aspects 64 through 67, further comprising: outputting, via the information, a first reference signal sequence associated with the plurality of active periods and a second reference signal sequence associated with the plurality of non-active periods; and outputting a plurality of reference signals, the communicating based at least in part on whether the plurality of reference signals is associated with the first reference signal sequence, or the second reference signal sequence, or both.
Aspect 69: The method of any of aspects 64 through 68, further comprising: outputting, via the information, a first reference signal sequence associated with the cell discontinuous operation and a second reference signal sequence associated with an absence of the cell discontinuous operation; and outputting one or more reference signals, the communicating based at least in part on whether the one or more reference signals are associated with the first reference signal sequence or the second reference signal sequence.
Aspect 70: The method of any of aspects 64 through 69, further comprising: outputting, via the information, a first set of resources for communication within the plurality of active periods and a second set of resources for communication within the plurality of non-active periods, the communicating based at least in part on the first set of resources and the second set of resources.
Aspect 71: The method of any of aspects 64 through 70, further comprising: outputting, via the information, a first set of resources for communication associated with the cell discontinuous operation and a second set of resources for communication associated with an absence of the cell discontinuous operation, the communicating based at least in part on the first set of resources and the second set of resources.
Aspect 72: The method of any of aspects 64 through 71, further comprising: outputting, via the information, a counter value threshold, the communicating based at least in part on outputting the counter value threshold.
Aspect 73: The method of any of aspects 64 through 72, further comprising: obtaining, from the one or more UEs, an indication of a failure to receive the activation message or the deactivation message associated with the cell discontinuous operation based at least in part on outputting the one or more control messages.
Aspect 74: The method of aspect 73, further comprising: obtaining an indication that an unknown cell discontinuous transmission configuration has been activated; obtaining an indication that a cell discontinuous transmission configuration has been activated and that the cell discontinuous transmission configuration is within a set of cell discontinuous transmission configurations; or obtaining an indication that a known cell discontinuous transmission configuration has been activated.
Aspect 75: A apparatus for wireless communications at a UE, comprising at least one means for performing a method of any of aspects 27 through 52.
Aspect 76: A non-transitory computer-readable medium storing code for wireless communications, the code comprising instructions executable by one or more processors to cause a UE to perform a method of any of aspects 27 through 52.
Aspect 77: A apparatus for wireless communications at a network entity, comprising at least one means for performing a method of any of aspects 64 through 74.
Aspect 78: A non-transitory computer-readable medium storing code for wireless communications, the code comprising instructions executable by one or more processors to cause a network entity to perform a method of any of aspects 64 through 74.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive one or more control messages that include information associated with a detection of an activated cell discontinuous operation or a deactivated cell discontinuous operation, the activated cell discontinuous operation associated with a cycle that includes a plurality of active periods and a plurality of non-active periods, the information to differentiate a first communication during the plurality of active periods from a second communication outside of the plurality of active periods; and
indicate, based at least in part on the detection, a failure to receive an activation message or a deactivation message associated with a cell discontinuous operation.

2. The apparatus of claim 1, the one or more processors further configured to cause the UE to:
receive, via the information, one or more measurement value thresholds associated with the first communication, the second communication, or both, the indication of the failure based at least in part on a comparison of a plurality of measurements to the one or more measurement value thresholds.

3. The apparatus of claim 2, the plurality of measurements comprising one or more first measurements within a first time period and one or more second measurements within a second time period, and, to indicate the failure, the one or more processors configured to cause the UE to:
indicate a failure to receive the activation message based at least in part on a determination that the one or more first measurements satisfy a first threshold of the one or more measurement value thresholds and a determination that the one or more second measurements fail to satisfy a second threshold of the one or more measurement value thresholds, the first threshold associated with the plurality of active periods and the second threshold associated with the plurality of non-active periods.

4. The apparatus of claim 3, the one or more first measurements within at least one of the plurality of active periods in accordance with the determination that the one or more first measurements satisfy the first threshold, and the one or more second measurements within at least one of the plurality of non-active periods in accordance with the determination that the one or more second measurements fail to satisfy the second threshold.

5. The apparatus of claim 2, the plurality of measurements comprising one or more first measurements within a first time period and one or more second measurements within a second time period, and, to indicate the failure, the one or more processors configured to cause the UE to:
indicate a failure to receive the deactivation message based at least in part on a determination that the one or more first measurements and the one or more second measurements satisfy a threshold of the one or more measurement value thresholds.

6. The apparatus of claim 2, the one or more processors further configured to cause the UE to:
receive a reference signal identifier of a reference signal, the plurality of measurements associated with the reference signal.

7. The apparatus of claim 2, the plurality of measurements associated with one or more reference signal received power measurements, one or more cross link interference measurements, or both.

8. The apparatus of claim 1, the one or more processors further configured to cause the UE to:
receive, via the information, a first reference signal sequence associated with the plurality of active periods and a second reference signal sequence associated with the plurality of non-active periods; and
receive a plurality of reference signals, the indication of the failure based at least in part on whether the plurality of reference signals is associated with the first reference signal sequence, or the second reference signal sequence, or both.

9. The apparatus of claim 8, the one or more processors further configured to cause the UE to:
receive, within a first time period, one or more first reference signals of the plurality of reference signals;
receive, within a second time period, one or more second reference signals of the plurality of reference signals; and
indicate a failure to receive the activation message based at least in part on the one or more first reference signals associated with the first reference signal sequence and the one or more second reference signals associated with the second reference signal sequence.

10. The apparatus of claim 8, the one or more processors, to indicate the failure, further configured to cause the UE to:
indicate a failure to receive the deactivation message based at least in part on the plurality of reference signals associated with the first reference signal sequence.

11. The apparatus of claim 1, the one or more processors, to indicate the failure, further configured to cause the UE to:
receive, via the information, a first reference signal sequence associated with the cell discontinuous operation and a second reference signal sequence associated with an absence of the cell discontinuous operation; and
receive one or more reference signals, the indication of the failure based at least in part on whether the one or more reference signals are associated with the first reference signal sequence or the second reference signal sequence.

12. The apparatus of claim 11, the one or more processors, to indicate the failure, further configured to cause the UE to:
indicate a failure to receive the activation message based at least in part on the one or more reference signals associated with the first reference signal sequence.

13. The apparatus of claim 11, the one or more processors, to indicate the failure, further configured to cause the UE to:
indicate a failure to receive the deactivation message based at least in part on the one or more reference signals associated with the second reference signal sequence.

14. The apparatus of claim 1, the one or more processors further configured to cause the UE to:
receive, via the information, a first set of resources for communication within the plurality of active periods and a second set of resources for communication within the plurality of non-active periods, the indication of the failure based at least in part on the first set of resources and the second set of resources.

15. The apparatus of claim 14, the one or more processors further configured to cause the UE to:
transmit, within a first time period, one or more first scheduling requests in accordance with the first set of resources;
transmit, within a second time period, one or more second scheduling requests in accordance with the first set of resources; and
indicate a failure to receive the activation message based at least in part on a determination that a difference between one or more first failures of the one or more first scheduling requests and one or more second failures of the one or more second scheduling requests satisfies a threshold.

16. The apparatus of claim 14, the one or more processors further configured to cause the UE to:
transmit, within a first time period, one or more first scheduling requests in accordance with the first set of resources;
transmit, within a second time period, one or more second scheduling requests in accordance with the second set of resources; and
indicate a failure to receive the deactivation message based at least in part on a determination that a difference between one or more first failures of the one or more first scheduling requests and one or more second failures of the one or more second scheduling requests satisfies a threshold.

17. The apparatus of claim 14, the one or more processors further configured to cause the UE to:
transmit, within a first time period, one or more first scheduling requests in accordance with the first set of resources;
transmit, within a second time period, one or more second scheduling requests in accordance with the second set of resources based at least in part on a failure of the one or more first scheduling requests; and
indicate a failure to receive the activation message based at least in part on a success of the one or more second scheduling requests.

18. The apparatus of claim 14, the one or more processors further configured to cause the UE to:
transmit, within a first time period, one or more first scheduling requests in accordance with the second set of resources;
transmit, within a second time period, one or more second scheduling requests in accordance with the first set of resources based at least in part on a failure of the one or more first scheduling requests; and
indicate a failure to receive the deactivation message based at least in part on a success of the one or more second scheduling requests.

19. The apparatus of claim 1, the one or more processors further configured to cause the UE to:
receive, via the information, a first set of resources for communication associated with the cell discontinuous operation and a second set of resources for communication associated with an absence of the cell discontinuous operation, the indication of the failure based at least in part on the first set of resources and the second set of resources.

20. The apparatus of claim 19, the one or more processors further configured to cause the UE to:
transmit, within a first time period, one or more first scheduling requests in accordance with the first set of resources;
transmit, within a second time period, one or more second scheduling requests in accordance with the first set of resources; and
indicate a failure to receive the activation message based at least in part on a determination that a difference between one or more first failures of the one or more first scheduling requests and one or more second failures of the one or more second scheduling requests satisfies a threshold.

21. The apparatus of claim 19, the one or more processors further configured to cause the UE to:
transmit, within a first time period, one or more first scheduling requests in accordance with the first set of resources;
transmit, within a second time period, one or more second scheduling requests in accordance with the second set of resources; and
indicate a failure to receive the deactivation message based at least in part on a determination that a difference between one or more first failures of the one or more first scheduling requests and one or more second failures of the one or more second scheduling requests satisfies a threshold.

22. The apparatus of claim 19, the one or more processors further configured to cause the UE to:
transmit, within a first time period, one or more first scheduling requests in accordance with the first set of resources;
transmit, within a second time period, one or more second scheduling requests in accordance with the second set of resources based at least in part on a failure of the one or more first scheduling requests; and
indicate a failure to receive the activation message based at least in part on a success of the one or more second scheduling requests.

23. The apparatus of claim 19, the one or more processors further configured to cause the UE to:
transmit, within a first time period, one or more first scheduling requests in accordance with the second set of resources;
transmit, within a second time period, one or more second scheduling requests in accordance with the first set of resources based at least in part on a failure of the one or more first scheduling requests; and
indicate a failure to receive the deactivation message based at least in part on a success of the one or more second scheduling requests.

24. The apparatus of claim 1, further comprising:
an antenna array, the one or more processors further configured to cause the UE to:
receive, via the antenna array, a counter value threshold via the information; and
increment a counter based at least in part on based at least in part on a satisfaction of one or more criteria included in the information, the indication of the failure to receive the activation message or the deactivation message based at least in part on a determination that the counter satisfies the counter value threshold.

25. The apparatus of claim 1, the one or more processors, to indicate the failure, further configured to cause the UE to:
indicate that an unknown cell discontinuous transmission configuration has been activated;
indicate that a cell discontinuous transmission configuration has been activated and that the cell discontinuous transmission configuration is within a set of cell discontinuous transmission configurations; or
indicate that a known cell discontinuous transmission configuration has been activated.

26. An apparatus for wireless communication at a network entity, comprising:
one or more memories; and
one or more processors coupled with the one or more memories and configured to cause the network entity to:
output one or more control messages that include information associated with a detection of an activated cell discontinuous operation or a deactivated cell discontinuous operation, the cell discontinuous operation associated with a cycle that includes a plurality of active periods and a plurality of non-active periods, the information to differentiate a first communication during the plurality of active periods from a second communication outside of the plurality of active periods;
output an activation message or a deactivation message associated with a cell discontinuous operation; and
communicate with one or more user equipments (UEs) based at least in part on the output of the activation message or the deactivation message and the one or more control messages.

27. The apparatus of claim 26, the one or more processors further configured to cause the network entity to:
output, via the information, one or more measurement value thresholds associated with the first communication, the second communication, or both, the communication with one or more UEs based at least in part on the one or more measurement value thresholds.

28. The apparatus of claim 27, the one or more processors further configured to cause the network entity to:
output a reference signal identifier of a reference signal, a plurality of measurements by the one or more UEs associated with the reference signal.

29. The apparatus of claim 27, the one or more measurement value thresholds associated with one or more reference signal received power measurements, one or more cross link interference measurements, or both.

30. The apparatus of claim 26, the one or more processors further configured to cause the network entity to:
output, via the information, a first reference signal sequence associated with the plurality of active periods and a second reference signal sequence associated with the plurality of non-active periods; and
output a plurality of reference signals, the communication based at least in part on whether the plurality of reference signals is associated with the first reference signal sequence, or the second reference signal sequence, or both.

31. The apparatus of claim 26, the one or more processors further configured to cause the network entity to:
output, via the information, a first reference signal sequence associated with the cell discontinuous operation and a second reference signal sequence associated with an absence of the cell discontinuous operation; and
output one or more reference signals, the communication based at least in part on whether the one or more reference signals are associated with the first reference signal sequence or the second reference signal sequence.

32. The apparatus of claim 26, the one or more processors further configured to cause the network entity to:
output, via the information, a first set of resources for communication within the plurality of active periods and a second set of resources for communication within the plurality of non-active periods, the communication based at least in part on the first set of resources and the second set of resources.

33. The apparatus of claim 26, the one or more processors further configured to cause the network entity to:
output, via the information, a first set of resources for communication associated with the cell discontinuous operation and a second set of resources for communication associated with an absence of the cell discontinuous operation, the communication based at least in part on the first set of resources and the second set of resources.

34. The apparatus of claim 26, the one or more processors further configured to cause the network entity to:
output, via the information, a counter value threshold, the communication based at least in part on the output of the counter value threshold.

35. The apparatus of claim 26, further comprising:
an antenna array, the one or more processors further configured to cause the network entity to:
obtain, from the one or more UEs via the antenna array, an indication of a failure to receive the activation message or the deactivation message associated with the cell discontinuous operation based at least in part on the output of the one or more control messages.

36. The apparatus of claim 35, the one or more processors further configured to cause the network entity to:
obtain an indication that an unknown cell discontinuous transmission configuration has been activated;
obtain an indication that a cell discontinuous transmission configuration has been activated and that the cell discontinuous transmission configuration is within a set of cell discontinuous transmission configurations; or
obtain an indication that a known cell discontinuous transmission configuration has been activated.

37. A method for wireless communications at a user equipment (UE), comprising:
receiving one or more control messages that include information associated with a detection of an activated cell discontinuous operation or a deactivated cell discontinuous operation, the activated cell discontinuous operation being associated with a cycle that includes a plurality of active periods and a plurality of non-active periods, the information differentiating a first communication during the plurality of active periods from a second communication outside of the plurality of active periods; and
indicating, based at least in part on the detection, a failure to receive an activation message or a deactivation message associated with a cell discontinuous operation.

38. A method for wireless communications at a network entity, comprising:
outputting one or more control messages that include information associated with a detection of an activated cell discontinuous operation or a deactivated cell discontinuous operation, the cell discontinuous operation being associated with a cycle that includes a plurality of active periods and a plurality of non-active periods, the information differentiating a first communication during the plurality of active periods from a second communication outside of the plurality of active periods;
outputting an activation message or a deactivation message associated with a cell discontinuous operation; and
communicating with one or more user equipments (UEs) based at least in part on outputting the activation message or the deactivation message and the one or more control messages.
